(19) United States
(12) Patent Application Publication
(10) Pub. No.: US 2024/0288789 A1
(43) Pub. Date: Aug. 29, 2024

(54) RESIN PARTICLE, TONER, DEVELOPING AGENT, DEVELOPING AGENT ACCOMMODATING UNIT, METHOD OF MANUFACTURING RESIN PARTICLE, IMAGE FORMING APPARATUS, AND IMAGE FORMING METHOD

(71) Applicants: Kohsuke Satoh, Shizuoka (JP); Akira Tanaka, Shizuoka (JP); Taro Araki, Shizuoka (JP); Hiroki Araya, Kanagawa (JP)

(72) Inventors: Kohsuke Satoh, Shizuoka (JP); Akira Tanaka, Shizuoka (JP); Taro Araki, Shizuoka (JP); Hiroki Araya, Kanagawa (JP)

(73) Assignee: Ricoh Company, Ltd., Tokyo (JP)

(21) Appl. No.: 18/581,614

(22) Filed: Feb. 20, 2024

(30) Foreign Application Priority Data
Feb. 22, 2023 (JP) 2023-026639

(51) Int. Cl. G03G 9/093; C08G 63/16

(52) U.S. Cl. CPC G03G 9/09328; C08G 63/16

(57) ABSTRACT

A resin particle contains a binder resin containing a biomass-derived resin and a recycle-based resin, the resin particle including a core-shell structure including a core layer and a shell layer that contains a resin having a sulfonic acid salt group, wherein, in the binder resin, a proportion (percent by mass) of the biomass-derived resin and a proportion (percent by mass) of the recycle-based resin satisfy the following relationship 1:

proportion of recycle-based resin>proportion of biomass-derived resin Relationship 1.

### CROSS-REFERENCE TO RELATED APPLICATIONS

This patent application is based on and claims priority pursuant to 35 U.S.C. § 119 to Japanese Patent Application No. 2023-026639, filed on Feb. 22, 2023, in the Japan Patent Office, the entire disclosure of which is hereby incorporated by reference herein.

### BACKGROUND

### Technical Field

The present disclosure relates to a resin particle, a toner, a developing agent, a developing agent accommodating unit, a method of manufacturing a resin particle, an image forming apparatus, and an image forming method.

### Description of the Related Art

Carbon neutral is a term generally used to define a property related to biomass substances typically composed of organic matter. When these biomass substances are combusted, carbon dioxide is emitted. The carbon in this emitted carbon dioxide is derived from carbon dioxide absorbed from the atmosphere during the growth process of the biomass substances through photosynthesis. Therefore, using biomass substances is considered not to increase the overall atmospheric carbon dioxide levels. This way of thinking is referred to as carbon neutrality.

Traditionally, the materials used in toner, especially the binding resins, have heavily relied on fossil resources. Carbon dioxide generated from discarded toner and print images is released into the atmosphere, contributing to global warming. The transition from finite fossil resources to renewable biomass resources is seen and desired as a shift toward sustainably renewable resources, as life forms are generated from solar energy, water, and carbon dioxide.

Toner materials obtained from such renewable resources include release agents like Carnauba wax and Candelilla wax. These are added to toner to provide release functionality during fixing, and their inclusion is typically at a few weight percentages, making it challenging to achieve carbon neutrality through these alone.

In recent years, with the increase in population leading to expanded energy use and resource depletion, there has been a growing emphasis on resource conservation, energy efficiency, and resource recycling. Specifically, local towns and cities have already started recycling polyethylene terephthalate (PET) bottles. Recycled bottles are used for clothes and containers. Reusing recycled PET is also expected in new application fields. From this point of view, toner (recycled toner) containing a binder resin made from collected polyethylene terephthalate has already appeared.

Currently, toner should enhance its functions, using biomass-derived resin that enhances environmental compatibility.

### SUMMARY

According to embodiments of the present disclosure, a resin particle is provided that contains a binder resin containing a biomass-derived resin and a recycle-based resin, the resin particle including a core-shell structure including a core layer and a shell layer that contains a resin having a sulfonic acid salt group, wherein, in the binder resin, the proportion (percent by mass) of the biomass-derived resin and the proportion (percent by mass) of the recycle-based resin satisfy the following relationship 1:

proportion of recycle-based resin>proportion of biomass-derived resin Relationship 1.

As another aspect of embodiments of the present disclosure, a toner is provided that contains a mother toner particle containing the resin particle mentioned above and an external additive added to the mother toner particle.

As another aspect of embodiments of the present disclosure, a developing agent accommodating unit is provided that includes the developing agent mentioned above and a body that contains the developing agent.

As another aspect of embodiments of the present disclosure, a method of manufacturing the resin particle is provided that includes dissolving or dispersing at least one of the binder resin comprising the biomass-derived resin and the recycle-based resin or a precursor of the binder resin in an organic solvent to obtain a solution, adding water to the solution to induce a phase inversion of a water-in-oil liquid dispersion to an oil-in-water liquid dispersion, removing the organic solvent from the oil-in-water liquid dispersion to obtain a fine particle liquid dispersion, aggregating fine particles in the fine particle liquid dispersion to obtain aggregated particle, forming the shell layer containing a polyester resin with a sulfonic acid salt group on the aggregated particle, fusing the aggregated particle having the shell layer to obtain a fused aggregated particle, annealing the fused aggregated particle to obtain an annealed particle, and rinsing and drying the annealed particle.

As another aspect of embodiments of the present disclosure, an image forming apparatus is provided that includes a latent electrostatic image bearer, a latent electrostatic image forming device for forming a latent electrostatic image on the latent electrostatic image bearer, a developing device for developing the latent electrostatic image with the toner mentioned above or the developing agent mentioned above 10 to form a visible image. a transfer device for transferring the visible image onto a recording medium to obtain a transfer image, and a fixing device for fixing the transfer image transferred to the recording medium.

As another aspect of embodiments of the present disclosure, an image forming method is provided that includes forming a latent electrostatic image on a latent electrostatic image bearer, developing the latent electrostatic image with the toner mentioned above or the developing agent mentioned above to obtain a visible image, transferring the visible image to a recording medium; and fixing the visible image on the recording medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an image forming apparatus according to an embodiment of the present invention; and

FIG. 2 is a schematic diagram illustrating an example of a process cartridge using an embodiment of the present invention.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a resin particle is provided that can form an environment-friendly toner, excelling in both adhesiveness and shelf life, as well as electrostatic properties and environmental stability.

In the first place, Aspects of the present invention are described as follows.

Aspect 1: The resin particle according to an embodiment of the present invention contains a binder resin containing a biomass-derived resin and a recycle-based resin, the resin particle including a core-shell structure including a core layer and a shell layer that contains a resin having a sulfonic acid salt group, wherein, in the binder resin, the proportion (percent by mass) of the biomass-derived resin and the proportion (percent by mass) of the recycle-based resin satisfy the following relationship 1:

proportion of recycle-based resin>proportion of biomass-derived resin Relationship 1.

In Aspect 1, the binder resin is preferably polyester resin. The polyester resin preferably gains more toughness by using BPA-PO or BPA-EO as the alcohol component, leading to a longer shelf life (storage stability) and enhanced durability. With biomass conversion, as alcohol components become plant-derived, the usage of BPA decreases, further leading to little or non-use of BPA, resulting in a decrease in the toughness of polyester resin and reduced storage and durability. Therefore, to achieve both fixability and stability, as well as durability, recycle-based resin is set to be dominant over biomass-derived resin.

The resin particle has a core-shell structure, consisting of a core layer and a shell layer that contains a sulfonic acid salt group. This core-shell structure ensures high temperature storage stability while the sulfonic acid salt group imparts a high chargeability due to its electrifying effect.

Aspect 2: In the resin particle described in Aspect 1 above, the shell layer has a polyester resin having a sulfonic acid salt group with an solubility parameter (SP) value of from 10 to 13 (cal/cm³)^{0.5}.

This SP value range of from 10 to 13 (cal/cm³)^{0.5} enables better forming of a shell layer on a core particle.

An SP value lower than 10 (cal/cm³)^{0.5} enhances hydrophobicity, reducing the likelihood of shell formation on the core. To the contrary, an SP exceeding 13 (cal/cm³)^{0.5} invites excessively strong hydrophilicity, making homoaggregation among shell resins dominant over heteroaggregation, resulting in inadequate formation of the shell layer.

It is preferable that the relationship among the SP values of the non-crystalline polyester resin in the core layer, the crystalline polyester resin in the core layer, and the resin in the shell layer satisfy the following relationship:

SP value of the resin in the shell layer>SP value of the non-crystalline polyester resin in the core layer>SP value of the crystalline polyester resin in the core layer.

According to the embodiments of the present invention described in Aspect 2 above, establishing the above relationship allows for the effective formation of the shell layer while maintaining the non-miscibility of the crystalline polyester resin. Non-miscibile crystalline polyester resin strikes a balance between fixability and storage stability.

Aspect 3: The resin particle of Aspects 1 and 2 above preferably contains the sulfonic acid salt group in a content of from 2 to 10 percent by mol.

In the embodiment of the present invention described in Aspect 3 above, the content of the sulfonic acid salt group in the polyester resin containing it is preferably from 2 to 10 percent by mol and more preferably from 4 to 8 percent by mol to the entire mass of the carboxylic acid monomers constituting the polyester resin.

Aspect 4: The resin particle according to any one of Aspects 1 to 3 above preferably contains the polyester resin containing a sulfonic acid salt group in an amount of from 5 to 40 percent by mass.

As in the embodiment of the present invention described in Aspect 4 above, a polyester resin containing a sulfonic acid salt group of 5 or more percent by mass positively affects charging performance and high-temperature storage stability, while maintaining a proportion of 40 or less percent by mass prevents degradation of low-temperature fixability.

Aspect 5: The resin particle according to any one of Aspects 1 to 4 above preferably contains the recycle-based resin and biomass-derived resin in an amount of at least 80 percent by mass.

According to the embodiment of the present invention described in Aspect 5 above, the resin particle enhances environmental compatibility, and simultaneously, it becomes possible to strike a balance between fixability and storage stability, and durability.

Aspect 6: In the resin particle according to any one of Aspects 1 to 5 above, the recycle-based resin and biomass-derived resin preferably contain at least one of polyethylene phthalate (PET) and polybutylene terephthalate (PBT).

Aspect 7: The resin particle described in any one of Aspects 1 to 6 preferably contains a polyester resin as the binder resin.

According to the embodiment of the present invention described in Aspect 7 above, the inclusion of polyester resin achieves good fixability and storage stability, along with durability.

Aspect 8: The resin particle described in any one of Aspects 1 to 7 preferably contains a crystalline polyester resin as the polyester resin.

According to the embodiment of the present invention described in Aspect 8 above, the inclusion of the crystalline polyester resin in the resin particle enhances the low temperature fixing performance.

Aspect 9: The resin particle described in any one of Aspects 1 to 8 further contains a colorant and a release agent.

Aspect 10: A toner relating to an embodiment of the present invention contains the resin particle described in any one of Aspects 1 to 9 above with an external additive added to the resin particle.

Aspect 11: A developing agent relating to an embodiment of the present invention contains the toner described in Aspect 10 above.

Aspect 12: The developing agent accommodating unit relating to an embodiment of the present invention contains the developing agent described in Aspect 11 above.

Aspect 13: The method of manufacturing a resin particle containing at least a binder resin relating to an embodiment of the present invention is a method of manufacturing the resin particle of any one of Aspects 1 to 9 above including the following processes:
Process a: dissolving or dispersing at least one of a binder resin containing the biomass-derived resin and the recycle-based resin and a precursor of the binder resin in an organic solvent to obtain a solution;
Process b: adding water to the solution to induce a phase inversion of a water-in-oil liquid dispersion to an oil-in-water liquid dispersion;
Process c: removing the organic solvent from the oil-in-water liquid dispersion to obtain a fine particle liquid dispersion; and
Process d: aggregating fine particles of the fine particle liquid dispersion to obtain aggregated particles;
Process e: forming the shell layer containing the polyester resin with a sulfonic acid salt group on the aggregated particle;
Process f: fusing the aggregated particle having the shell layer to obtain a fused aggregated particle;
Process g: subjecting the fused aggregated particle to annealing to obtain an annealed particle; and
Process h: rinsing and drying the annealed particle.

Aspect 14: In the method described in Aspect 13 above, it is preferable to contain a prepolymer with a functional group reactive with an active hydrogen as the precursor of the binder resin.

According to the embodiment of the present invention described in Aspect 13 above, the use of a prepolymer is expected to improve low-temperature fixing performance due to its low glass transition temperature (Tg), while also enhancing hot offset performance, storage stability, and durability through careful selection of an elongating agent.

Aspect 15: An image forming apparatus relating to an embodiment of the present invention includes a latent electrostatic image bearer, a latent electrostatic image forming device for forming a latent electrostatic image on the latent electrostatic image bearer. a developing device for developing the latent electrostatic image with the toner of Aspect 10 above or the developing agent of Aspect 11 to form a visible image, a transfer device for transferring the visible image onto a recording medium to obtain a transfer image. And a fixing device for fixing the transfer image transferred to the recording medium.

Aspect 16: An image forming method relating to an embodiment of the present invention includes forming a latent electrostatic image on a latent electrostatic image bearer, developing the latent electrostatic image with the toner of Aspect 10 above or the developing agent of Aspect 11 to obtain a visible image, transferring the visible image to a recording medium, and fixing the visible image on the recording medium.

The resin particle, the toner, the developing agent, the developing agent accommodating unit, the method of manufacturing the resin particle, the image forming apparatus, and the image forming method related to the present disclosure are described with reference to the drawings. It is to be noted that the following embodiments are not limiting the present disclosure and any deletion, addition, modification, change, etc. can be made within a scope in which man in the art can conceive including other embodiments, and any of which is included within the scope of the present disclosure as long as the effect and feature of the present disclosure are demonstrated.

The resin particle of the present disclosure has a core-shell structure of a core layer with a shell layer.

In the specification of the present disclosure, “having a core-shell structure” means a structure including a core layer and a shell layer. The “shell layer” refers to a layer of resin present on the outermost surface of the resin particle while the “core layer” refers to the region inside the resin particle excluding the shell layer. The core layer and the shell layer are formed heterogeneously, not completely soluble in each other. In the core-shell structure, it is preferable that the surface of the core layer be covered in a form of being coated by the shell layer. It is acceptable for the surface of the core layer to be either completely or incompletely covered by the shell layer.

As a form in which the surface of the core layer is not completely covered by the shell layer, examples include the core layer being covered in a mesh-like pattern by the shell layer or the core layer being partially exposed from the shell layer. Preferably, the shell layer completely covers the core layer to enhance film-forming resistance.

This type of resin particle with a core-shell structure can be produced by a polymerization method, which includes processes such as the following:

Oil Phase Preparation Process: Preparation of a solution by dissolving or dispersing at least a binder resin and/or a precursor of the binder resin, as well as a colorant, in an organic solvent.

Phase Inversion Emulsification Process: Addition of water to the solution to induce a phase inversion from a water-in-oil liquid dispersion to a oil-in-water liquid dispersion.

Solvent Removal Process: Removal of the organic solvent from the oil-in-water liquid dispersion to obtain a fine particle liquid dispersion.

Aggregation Process: Aggregation of the fine particles in the fine particle liquid dispersion to obtain aggregated particles.

Shell Formation Process: Formation of a shell layer on the aggregated particles obtained in the aggregation process.

Fusion Process: Fusion of the aggregated particles with the shell layer obtained in the shell formation process through heat treatment to reduce irregularities and achieve sphericalization.

Rinsing and Drying Process: Rinsing of the liquid dispersion to extract resin particles and subsequent drying.

The following provides descriptions of the processes described above and the materials used in these processes.

### Process a (Oil Phase Preparation Process)

The process a involves preparing a solution in which at least a binder resin and/or a precursor of the binder resin, along with a colorant, are dissolved or dispersed in an organic solvent.

In the manufacturing method of the present disclosure, an oil phase is initially formed by dissolving or dispersing materials such as resin, a colorant, and a pre-polymer in an organic solvent. The oil phase is created by gradually adding substances such as resin and a colorant to the organic solvent under stirring, allowing them to dissolve or to be dispersed. For dissolution and dispersion, known devices such as a bead mill or disk mill can be used.

The materials used in preparing an oil phase are described below.

The resin particle of the present invention is suitable for use as toner. Toner is obtained by adding external additives to a mother toner particle containing the resin particle.

Below, the resin particle of the present disclosure will be explained using the toner as an embodiment of the resin particle of the present disclosure.

### Environmentally Compatible Resin

The term ‘environmentally compatible resin’ is also used to describe resins derived from biomass and recycled materials.

### Biomass-Derived Resin

Biomass-derived resin contains a compound derived from plants as raw materials. The alcohol and acid components, each with a ratio adjusted between petroleum-based and plant-based, can fine-tune the proportion of the environmentally compatible resin in the binder resin (also referred to as proportion of environmentally compatible resin) and toner quality.

The toner should have a concentration of radioactive carbon isotope ¹⁴C (referred to as ¹⁴C concentration) of at least 10.8 pMC, with a preference for a concentration of 20 or more pMC. If the ¹⁴C concentration is below 10.8 pMC, the biomass content is generally low, potentially hindering the achievement of the objectives outlined in the present disclosure.

The ¹⁴C concentration is expressed in the following relationship.

Biomass content (percent)=¹⁴C concentration (pMC)×0.935.

A ¹⁴C concentration of 10.8 or higher pMC implies a biomass content of 10 or more percent, which is desirable from a carbon-neutral perspective.

Achieving a biomass content of 10 or more percent requires considering biomass conversion not only for the wax in the toner but also for the binder resin.

There are no specific restrictions on the method of measuring the ¹⁴C concentration, and it can be suitably selected to suit to a particular application. Of these, radiocarbon dating is particularly preferable. The measurement procedure is as follows:

The toner is burnt to reduce carbondioxide (CO₂) in the particle, thereby obtaining graphite (C). Next, the ¹⁴C concentration in the graphite is measured using Accelerator Mass Spectroscopy (AMS). AMS measurement, for example, is disclosed in Japanese Patent No. 4050051.

¹⁴C is naturally present in the environment (in the atmosphere) and absorbed by plants during photosynthesis while they are active, resulting in an equilibrium concentration of ¹⁴C (107.5 pMC) within plants and the atmosphere. However, once plants cease their life activities, the uptake of ¹⁴C through photosynthesis stops, leading to a decrease in ¹⁴C concentration following its half-life of 5,730 years.

Due to the passage of several thousand to hundred million years since the cessation of life activities, ¹⁴C is scarcely detected in fossil resources originating from living organisms.

### Recycled-Derived Resin

As for recycle-based resin sources, there are PP (polypropylene), PE (polyethylene), PS (polystyrene), ABS (acrylonitrile-butadiene-styrene), PET (polyethylene terephthalate), and PBT (polybutylene terephthalate). Of these, PET and PBT are particularly preferable as materials for toner.

Recycled products are processed into PET and PBT flakes with a weight average molecular weight Mw of from about 30,000 to about 100,000. The molecular weight distribution, composition, method of manufacturing, shapes in the use of PET and PBT are not limiting. Moreover, the use of recycled materials is not limited to specific sources, and off-spec fiber scraps or pellets may also be employed. During the synthesis of polyester resin, the introduction ratio of recycled PET can be adjusted to regulate the environmentally compatible resin ratio and toner quality.

The amorphous polyester resin for use in the present disclosure are preferably obtained using a plant-derived alcohol component and an acid component to adjust the ratio of the environmental compatible resin. Also, using a polyester resin synthesized from PET and PBT is preferable.

As the plant-derived alcohol component, propylene glycol is preferable, while terephthalic acid and succinic acid are preferable as the acid component. However, the plant-derived components are not particularly limited to those above-mentioned. Any plant-derived is usable.

The proportion of recycle-based resin in the binder resin is preferably from 55 to 95 percent by mass and more preferably from 60 to 90 percent by mass. If the recycle-based resin proportion is less than 55 percent by mass, it may compromise high-temperature fixability, storage stability, and durability. Using petroleum-based resin to ensure these properties does not lead to an increase in the ratio of environmentally compatible resin. Exceeding 95 percent by mass may compromise the low-temperature fixability.

The proportion of biomass-derived resin in the binder resin is preferably from 5 to 45 percent by mass and more preferably from 10 to 40 percent by mass. If the biomass-derived resin proportion is less than 5 percent by mass, the use of petroleum-based resin becomes necessary to maintain low-temperature fixability, thereby preventing an increase in the ratio of environmentally compatible resin. Exceeding 45 percent by mass may compromise the high-temperature fixability, storage stability, and durability. Using petroleum-based resin to ensure these properties does not lead to an increase in the ratio of environmentally compatible resin.

The ratio of the recycle-based resin to the biomass-derived resin in the binder resin is preferably at 95:5 to 55:45, and more preferably 90:10 to 60:40.

If the recycle-based resin proportion is less than 55, it may compromise high-temperature fixability, storage stability, and durability. Using petroleum-based resin to ensure these properties does not lead to an increase in the ratio of environmentally compatible resin.

Exceeding 95 may compromise the low-temperature fixability.

If the biomass-derived resin proportion is less than 5, it is necessary to use petroleum-based resin to ensure the low-temperature fixability, which does not lead to an increase in the environmental compatible resin ratio. Exceeding 45 may compromise the high-temperature fixability, storage stability, and durability. Using petroleum-based resin to ensure these properties does not lead to an increase in the ratio of environmentally compatible resin.

### Polyester Resin

If used as a toner for electrostatic latent image development in electrophotography, utilizing a resin with a polyester backbone ensures excellent fixability. Resins with a polyester backbone include polyester resins and block copolymers of polyester resins with resins with other backbones, but using polyester resin is preferable to obtain colored resin particles with a higher uniformity.

As for the polyester resin, examples include lactone ring-opening polymers, condensed polymers of hydroxycarboxylic acids, condensed polymers of polyols and polycarboxylic acids. From the standpoint of freedom of designing, condensed polymers of polyols and polycarboxylic acids are preferred.

The weight average molecular weight of the polyester resin is from 1,000 to 30,000, preferably from 3,000 to 15,000, and more preferably from 5,000 to 12,000. A weight average molecular weight of less than 1,000 worsens the high temperature stability. A weight average molecular weight surpassing 30,000 has a negative impact on the low temperature fixability.

Additionally, the glass transition temperature of the polyester resin should range from 35 to 80 degrees C., with a preference for temperatures between 40 and 70 degrees C., and an even stronger preference for temperatures between 45 and 65 degrees C. Temperatures below 35 degrees C. may result in deformation of the colored resin particles when exposed to high-temperature environments such as during midsummer, or the particles may adhere together, preventing them from functioning as intended individual particles. Conversely, exceeding 80 degrees C., can result in poor fixability when the colored resin particles are used as a toner for electrostatic latent image development.

### Polyol

Examples of the polyol (1) are diol (1-1) and polyol (triol or higher polyol) (1-2) and using diol (1-1) or a mixture of diol (1-1) with a small amount of (1-2) is preferred.

Diol (1-1) includes the following, for example.

Specific examples of the polyols (1) include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F, and bisphenol S); adducts of the above-mentioned alicyclic diols with alkylene oxides such as ethylene oxide, propylene oxide, and butylene oxide; 4,4′-dihydroxybiphenyls such as 3,3′-difluoro-4,4′-dihydroxybiphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also referred to as tetrafluorobisphenol A), and 2,2-bis(3-hydroxyphnyl)-1,1,1,3,3,3-hexafluoropropane; bis(4-hydorxyphenyl)ethers such as bis(3-fluoro-4-hydroxyphenyl)ether; and adducts of the bisphenols mentioned above with an alkylene oxide (e.g., ethylene oxide, propylene oxide and butylene oxide).

Alkylene glycols having 2 to 12 carbon atoms and adducts of a bisphenol with an alkylene oxide are preferable. A mixture of an adduct of a bisphenol with an alkylene oxide and an alkylene glycol having 2 to 12 carbon atoms is particularly preferable.

Specific examples of the polyols (1-2) include, but are not limited to, aliphatic acid alcohols having three or more hydroxyl groups (e.g., glycerin, trimethylol ethane, trimethylol propane, pentaerythritol and sorbitol); polyphenols having three or more hydroxyl groups (trisphenol PA, phenol novolak, and cresol novolak); and adducts of the tri- or higher polyphenols mentioned above with an alkylene oxide.

### Polycarboxylic Acid

Specific examples of polycarboxylic acids (2) include, but are not limited to, dicarboxylic acids (2-1) and polycarboxylic acids (2-2) having three or more carboxyl groups. Of these, using the dicarboxylic acid (2-1) alone or a mixture of the dicarboxylic acid (2-1) with a small amount of polycarboxylic acids (2-2) having three or more carboxyl groups is preferable.

Specific examples of the dicarboxylic acids (2-1) include, but are not limited to, alkylene dicarboxylic acids (e.g., succinic acid, adipic acid and sebacic acid); alkenylene dicarboxylic acids (e.g., maleic acid and fumaric acid); and aromatic dicarboxylic acids (e.g., phthalic acid, isophthalic acid, terephthalic acid, naphthalene dicarboxylic acids, 3-fluoroisophtahlic acid, 2-fluoroisophthalic acid, 2-fluoroterephtahlic acid, 2,4,5,6-tetrafluoroisophtahlic acid, 2,3,5,6-tetrafluoro terephthalic acid, 5-trifluoromthyl isophthalic acid, 2,2-bis(4-carboxyphenyl)hexafluoro propane, 2,2-bis(3-carboxyphenyl)hexafluoropropane, 2,2′-bis(trifluoromethyl)-4,4′-biphenyl dicarboxylic acid, 3,3′-bis(trifluoromethyl)4,4′-biphenyl dicarboxylic acid, 2,2′-bis(trifluoromethyl)-3,3′-biphenyl dicarboxylic acid, and hexafluoro isopropylidene diphthalic anhydride). Among these compounds, alkenylene dicarboxylic acids having 4 to 20 carbon atoms and aromatic dicarboxylic acids having 8 to 20 carbon atoms are preferable.

Specific examples of the polycarboxylic acids (2-2) having three or more hydroxyl groups include, but are not limited to, aromatic polycarboxylic acids having from 9 to 20 carbon atoms (e.g., trimellitic acid and pyrromellitic acid). In addition, compounds prepared by reaction between anhydrides or lower alkyl esters (e.g., methyl esters, ethyl esters or isopropyl esters) of the polycarboxylic acids mentioned above and polyols (1) can be used as the polycarboxylic acid (2).

The suitable mixing ratio (i.e., an equivalence ratio [OH]/[COOH]) of a polyol to a polycarboxylic acid is from 2/1 to 1/2, preferably from 1.5/1 to 1/1.5 and more preferably from 1.3/1 to 1/1.3.

### Colorant

The suitable colorant (coloring material) in the present disclosure includes known dyes and pigments.

Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Faise Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone BlueFast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

### Organic Solvent

As the organic solvent, a volatile organic solvent with a boiling point lower than 100 degrees C. is preferable to readily remove the organic solvent later.

Specific examples of the organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone, methylisobuthyl ketone, methanol, ethanol, and isopropyl alcohol. These can be used alone or in combination. A resin having a polyester backbone is well dissolved or dispersed in an organic solvent such as ester-based solvents including methyl acetate, ethyl acetate, and butyl acetate or ketone-based solvents including methylethyl ketone and methyl isobutyl ketone. Of these, methyl acetate, ethyl acetate, and methyl ethyl ketone are particularly preferable to readily purge a dispersion of the organic solvent later.

### Prepolymer

One of the prepolymers, reactive precursors, is a polyester with a group reactive with an active hydrogen group.

Specific examples of the group reactive with an active hydrogen group include, but are not limited to, an isocyanate group, an epoxy group, a carboxylic acid, and an acid chloride group. Of these, an isocyanate group is preferable to introduce a urethane or urea bond into an amorphous polyester resin.

The prepolymer may have a branched structure attributed by at least one of tri- or higher alcohol and tri- or higher carboxylic acid.

One example of the polyester resin containing an isocyanate group is a reaction product of a polyisocyanate and a polyester resin with an active hydrogen group. One way of obtaining a polyester resin with an active hydrogen group is to polycondense a diol with a dicarboxylic acid or a tri- or higher alcohol with a tri- or higher carboxylic acid. A tri- or higher alcohol and a tri- or higher carboxylic acid provides a branched structure to a polyester resin with an isocyanate group.

Specific examples of the diols include, but are not limited to, aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol and 1,12-dodecanediol, diols having oxyalkylene groups such as diethylene glycol, triethylene glycol, dipropylene glycol, polyethylene glycol, polypropylene glycol and polytetramethylene glycol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide. Of these, aliphatic diols having 3 to 10 carbon atoms such as 1,2-propylene glycol, 1,3-propylene glycol, 1,4-butanediol, 2-methyl-1,3-propanediol, 1,5-pentanediol, and 3-methyl-1,5-pentanediol are preferable to adjust the glass transition temperature of a polyester resin to 20 degrees C. or lower. Using these aliphatic diol at a proportion of 50 percent by mol or greater to the alcohol components in a resin is more preferable. These diols can be used alone or in combination.

The polyester resin is preferably amorphous, and introducing steric hindrance to the resin chains reduces the melt viscosity during fixing, making low-temperature fixability more readily apparent. Therefore, it is preferable for the main chain of the aliphatic diol to have the structure represented by the following Chemical Formula 1.

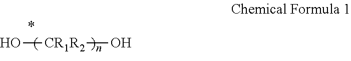

In Chemical Formula 1, R₁ and R₂ each independently represent hydrogen atoms or alkyl groups with 1 to 3 carbon atoms and n represents an odd integer of from 3 to 9. R₁ and R₂ each independently can be the same or different in the n repeating units.

The main chain of an aliphatic diol in the present disclosure refers to the carbon chain linked between the two hydroxy groups of the aliphatic diol by the minimal number. An odd number of carbon atoms in the main chain is preferable because crystallinity deteriorates by parity. In addition, aliphatic diol with at least one alkyl group having 1 to 3 carbon atoms in the side chain is preferable, which decreases the mutual action energy between the molecules in the main chain because of steric conformation.

Specific examples of the dicarboxylic acids include, but are not limited to, aliphatic dicarboxylic acids such as succinic acid, adipic acid, sebacic acid, dodecanedioic acid, maleic acid, and fumaric acid and aromatic dicarboxylic acids such as phthalic acid, isophthalic acid, terephthalic acid, naphthalene dicarboxylic acids. In addition, their anhydrides, lower (i.e., 1 to 3 carbon atoms) alkyl esterified compound, and halogenated compounds can be used. Of these, aliphatic dicarboxylic acid with 4 to 12 carbon atoms is preferable to achieve a glass transition temperature Tg of a polyester resin of 20 or lower degrees C. Using 50 or more percent by mass of the carboxylic acid component in a resin is more preferable. These dicarboxylic acids can be used alone or in combination.

Specific examples of tri- or higher alcohols include, but are not limited to, tri- or higher aliphatic alcohols such as glycerin, trimethylolethane, trimethylolpropane, pentaerythritol, and sorbitol; tri- or higher polyphenols such as trisphenol PA, phenol novolac, and cresol novolac; and adducts of alkylene oxide such as ethylene oxide, propylene oxide, and butylene oxide with trihydric or higher polyphenols.

One example of tri or higher carboxylic acids is a tri- or higher aromatic carboxylic acid. Tri- or higher aromatic carboxylic acids with 9 to 20 carbon atoms such as trimellitic acid and pyromellitic acid are preferable. In addition, their anhydrides, lower (i.e., 1 to 3 carbon atoms) alkyl esterified compound, and halogenated compounds can be used.

Examples of the polyisocyanate include, but are not limited to, diisocyanate and tri- or higher isocyanate.

The polyisocyante is not particularly limited and can be suitably selected to suit to a particular application.

Specific examples include, but are not limited to, aromatic diisocyanates such as either or both of 1,3- and 1,4-phenylene diisocyanate, of 2,4- and 2,6-tolylene diisocyanate (TDI), of crude TDI, of 2,4′- and 4,4′-diphenyl methane diisocyanate (MDI), and of crude MDI [phosgenated compounds of crude diamonophenyl methane (condensed product of formaldehyde and aromatic amine (aniline) or with a their mixture; a mixture of diaminodiphenyl methane and a small amount (e.g., 5 to 20 percent by mass) of tri- or higher polyamine]: polyallyl polyisocyanat (PAPI)], 1,5-naphtylene didsocyanate, 4,4′,4″-triphenylmethane triisocyanate, m- and p-isochyanato phenylsupphonyl isocyanate; aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatocthyl) fumarate, bis(2-isocyanatocthyl) carbonate, and 2-isocyanatocthyl-2,6-diisocyanatohexanoate; alicyclic diisocyanates such as isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate and 2,5- and 2,6-norbornane diisocyanate; aromatic aliphatic diisocyanates such as m- and p-xylylene diisocyanate (XDI) and α,α,α′,α′-tetramethylxylylene diisocyanate (TMXDI); tri- or higher polyisocyanates such as lysine triisocyanate and diisocyanate modified products of tri- or higher alcohols; and modified products of these isocyanates. Mixtures of two or more types mentioned above can be used. Specific examples of the modified products of isocyanate include, but are not limited to, modified compounds having a urethane group, a carbodiimide group, an allophanate group, a urea group, a biuret group, a uretdione group, a uretonimine group, an isocyanulate group, or an oxazoline group.

### Charge Control Agent

The oil phase may contain additives such as a charge control agent.

Specific examples of the charge control agent include, but are not limited to, known charge control agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, and metal salts of salicylic acid derivatives.

Specific examples of the procurable charge control agents include, but are not limited to, BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, and a quaternary ammonium group. The charge control agent is employed in a quantity that allows it to exhibit its effectiveness without adversely affecting fixability and other properties. Its proportion in toner is preferably 0.5 to 5 percent by mas, and more preferably, 0.8 to 3 percent by mass.

### Process b (Phase Inversion Emulsification Process)

Process b: adding water to the solution obtained in Process a to induce the phase inversion of a water-in-oil liquid dispersion to an oil-in-water liquid dispersion;

In the present embodiment, after the oil phase is neutralized with a liquid such as ammonium water, deionized water is added to the neutralized oil phase to carry out emulsification by phase inversion from the water-in-oil liquid dispersion to an oil-in-water liquid dispersion, thus obtaining a fine particle liquid dispersion (also referred to as liquid dispersion of fine particles, microparticle liquid dispersion, atomized liquid dispersion.

### Process c (Solvent Removing Process)

In Process c, the oil-in water liquid dispersion obtained in Process b is purged of the organic solvent to obtain the atomized liquid dispersion.

One method for removing the organic solvent from the liquid dispersion of fine particles is to gradually increase the temperature of the entire system during stirring, allowing the organic solvent in liquid droplets to evaporate and be removed completely.

Another approach involves spraying the liquid dispersion of fine particles in a dried atmosphere during stirring to ensure the complete removal of the organic solvent in droplets. Alternatively, the organic solvent can be evaporated and removed under reduced pressure under stirring of the liquid dispersion of fine particles. The latter two methods can be employed in conjunction with the first one.

In the context of spraying atomized liquid dispersion into a drying atmosphere, achieved by heating various gases such as air, nitrogen, carbon dioxide, and combustion gas, the gas is typically heated to temperatures at or above the boiling point of the highest-boiling-point solvent in the liquid dispersion. Various airflow systems, including spray dryers, belt dryers, and rotary kilns, are commonly used for short processing durations to achieve the desired quality.

Through these methods, the atomized liquid dispersion can be obtained.

### Process d (Aggregation Process)

Process d involves aggregating the fine particles of the atomized liquid dispersion obtained in Process c to form aggregated particles.

The liquid dispersion of fine particles is agitated during the aggregation process until the desired particle size is achieved. To induce aggregation, conventional methods such as adding an aggregating agent (flocculant) and adjusting the pH can be employed. While the flocculant can be added directly, it is preferable to use an aqueous solution containing the flocculant to avoid local high concentrations. Additionally, it is preferable to gradually add the flocculant while monitoring the particle size of the aggregated particles.

It is preferable for the temperature of the liquid dispersion during aggregation to be close to the glass transition temperature (Tg) of the resin being used. If the temperature is too low, it can impede efficient aggregation progress, while excessively high temperatures can accelerate aggregation, resulting in the formation of coarse particles and deterioration of particle size distribution.

Once the target particle size is achieved, the aggregation process is halted. Methods of ceasing aggregation include adding salts with low ionic valency or chelating agents, adjusting the pH, lowering the temperature of the liquid dispersion, and diluting the concentration by adding a significant amount of aqueous medium.

Through these methods, a liquid dispersion of aggregated particles can be obtained. In the aggregation process, wax may be added as a release agent, and crystalline resins may be added for low temperature fixing. In such cases, a liquid dispersion of wax in an aqueous medium or a similar liquid dispersion of crystalline resin is prepared. By mixing this liquid dispersion with the liquid dispersion of fine particles and allowing aggregation, uniformly dispersed aggregates containing wax or crystalline resin can be obtained.

Below are descriptions about a sulfonic acid group-containing polyester resin, aggregating agent, and wax, along with a crystalline resin.

### Sulfonic Acid Group-Containing Polyester Resin

There are no specific restrictions on the alcohol and carboxylic acid used in the synthesis of the sulfonic acid group-containing polyester resin.

The components that can be included are listed as follows.

### Diol

Specific examples of the diols include, but are not limited to, aliphatic diols such as ethylene glycol, 1,2-propylene glycol, 1,3-propylene glycol, 1,4-butanediol, 3-methyl-1,5-pentanediol, 1,6-hexanediol, 1,8-octanediol, 1,10-decanediol and 1,12-dodecanediol, diols having oxyalkylene groups such as diethylene glycol, triethylene glycol, dipropylene glycol, polyethylene glycol, polypropylene glycol and polytetramethylene glycol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide.

### Dicarboxylic Acid

The dicarboxylic acid is not particularly limited and can be suitably selected to suit to a particular application. It includes an aliphatic dicarboxylic acid and an aromatic dicarboxylic acid, for example. Additionally, the use of their hydrates, lower alkyl esters (carbon number 1-3), or halides is permissible.

Examples include aliphatic dicarboxylic acids. They are not particularly limited and can be suitably selected to suit to a particular application. Specific examples include, but are not limited to, succinic acid, adipic acid, sebacic acid, dodecanedioic acid, maleic acid, and fumaric acid.

The aromatic dicarboxylic acid is not particularly limited and can be suitably selected to suit to a particular application.

Specific examples include, but are not limited to, phthalic acid, isophthalic acid, terephthalic acid, and naphthalenedicarboxylic acid. Among these, aliphatic dicarboxylic acids with a carbon number ranging from 4 to 12 are preferable.

These dicarboxylic acids can be used alone or in combination.

### Tri- or Higher Acid or Alcohol

Tri- or higher acids or alcohols can be used. These are not particularly limited and can be suitably selected to suit to a particular application. Specific examples include, but are not limited to, glycerin, trimethylolethane, trimethylolpropane (TMP), pentaerythritol, sorbitol, dipentaerythritol, trimellitic acid (TMA), and pyromellitic acid.

### Sulfonic Acid Group-Containing Monomer

The synthesis of the sulfonic acid group-containing polyester resin involves using a monomer containing a sulfonic acid group. As for monomers containing the sulfonic acid group, examples include, but are not limited to, aromatic sulfonic acid group-containing monomers and aliphatic sulfonic acid group-containing monomers. Among these, aromatic sulfonic acid group-containing monomers with a di- or higher valent carboxylic acid group are preferable.

As for aromatic dicarboxylic acids with a sulfonic acid group, specific examples include, but are not limited to, 5-sulfoisophthalic acid, 2-sulfoisophthalic acid, 4-sulfoisophthalic acid, 4-sulfo-2,6-naphthalenedicarboxylic acid, and sulfonic acid salrs of their esterifiable derivatives [such as lower alkyl (C1-4) esters (such as methyl ester and ethyl ester), and acid anhydrides].

As for aliphatic dicarboxylic acids with a sulfonic acid group, specific examples include, but are not limited to, sulfosuccinic acid and sulfonic acid salts of its esterifiable derivatives [such as lower alkyl (C1-4) esters (methyl ester and ethyl ester, acid anhydrides].

As sulfonic acid salts, examples include, but are not limited to, alkali metal salts (such as lithium, sodium, and potassium), alkaline earth metal salts (such as magnesium and calcium), ammonium salts, amine salts (mono-, di-, and tri-amines with hydroxyalkyl (C2-4) groups, including organic amine salts such as mono-, di-, and tri-ethylamine, mono-, di-, and tri-ethanolamine, and diethyl ethanolamine), and quaternary ammonium salts of these amines.

Of these, 5-sulfoisophthalic acid salts are preferable, with sodium and potassium salts of 5-sulfoisophthalic acid being particularly preferred.

### SP Value of Sulfonic Acid Salt Group-Containing Polyester Resin

In the present disclosure, the SP value of the sulfonic acid salt group-containing polyester resin is calculated by Fedors method based on the amount of the monomer used in manufacturing.

### Mean Volume Diameter (Volume Average Particle Diameter

There are no specific restrictions on the volume average particle diameter of the resin fine particle and it can be appropriately selected to suit to a particular application. However, it is preferable for the volume average particle diameter to be from 3 to 7 μm. Additionally, it is desirable for the ratio of the volume average particle diameter to the number average particle diameter to be 1.2 or less. Moreover, it is preferable to contain components with a volume average particle diameter of 2 or less μm in an amount of 1 to 10 number percent.

### Measurement of Volume Average Particle Diameter Dv and Number Average Particle Diameter Dn

The volume average particle diameter Dv and the number average particle diameter Dn) of the resin fine particle were measured by using a particle size measuring instrument (MULTISIZER III, available from BECKMAN COULTER INC.) with an aperture diameter of 100 μm and the measuring results were analyzed by an analysis software (BECKMAN COULTER MULTISIZER 3 VERSION 3.51) under the following conditions.

To be specific, 0.5 ml of 10 percent by mass surfactant (alkylbenzene sulfonate, NEOGEN SC-A, available from DKS Co., Ltd.) is placed in a 100 mL glass beaker. A total of 0.5 g of each toner was added in the beaker and stirred by a microspatula followed by adding 80 ml of deionized water to the mixture. The thus-obtained liquid dispersion is subjected to dispersion treatment for 10 minutes utilizing an ultrasonic wave dispersion device (W-113MK-II, available from by Honda Electronics Co., Ltd.). The liquid dispersion was measured with the MULTISIZER III using ISOTON® III (available from BECKMAN COULTER INC.) as the measuring solution. The measurement involves adding the toner sample dispersion dropwise to the device until the indicated concentration reaches 8±2 percent.

### Average Circularity

In the formation of toner from the resin fine particles, it is preferable for the average circularity with a range of from 0.940 to less than 0.980 to exhibit a specific shape. When the average circularity is below 0.940, irregularly shaped toner particles deviating significantly from a spherical form result in poor image quality, characterized by unsatisfactory transferability and the generation of debris. Toner particles with an average circularity of 0.980 or less encounter cleaning issues on components such as the image bearer and transfer belt, leading to dirt on the image when a system employs blade cleaning.

The average circularity of the resin fine particles is measured using a Flow Particle Image Analysis system (FPIA-3000; available from Sysmex Corporation) followed by analysis using an analysis software (FPIA-3000 FLOW PARTICLE IMAGE ANALYZER version 00-11 under the following conditions.

To be specific, 0.1 to 0.5 ml of 10 percent by mass surfactant (alkylbenzene sulfonate, NEOGEN SC-A, available from DKS Co., Ltd.) is placed in a 100 mL glass beaker. A total of 0.1 to 0.5 g of each toner is added in the beaker and stirred by a microspatula followed by adding 80 ml of deionized water to the mixture. The resulting dispersion is subjected to ultrasonic dispersion for 3 minutes using an ultrasonic wave dispersion device (available from Honda Electronics Co., Ltd.). The shape and distribution of resin fine particles are measured until the concentration of the liquid dispersion achieves 5,000 to 15,000 particles/μl using FPIA-3000.

### Flocculant

Any known flocculants can be used. Examples include, but are not limited to, metal salts of monovalent metals such as sodium and potassium, metal salts of divalent metals such as calcium and magnesium, and metal salts of trivalent metals such as iron and aluminum.

Metal ions act as metal cross-linking agents, which cross-links polymer chains via the metal ions, resulting in aggregation. The metal cross-linking achieved by the metal cross-linking agent is expected to improve hot offset resistance, storage stability, and durability.

### Wax

Wax is not particularly limited and can be suitably selected to suit to a particular application. For example, a release agent having a low melting point of from 50 to 120 degrees C. is preferable. A release agent with a low melting point efficiently works at the interface between a fixing roller and the toner when dispersed with the resin mentioned above. For this reason, hot offset resistance becomes good even in an oil-free configuration, in which a release agent like oil is not applied to a fixing roller.

The release agent preferably includes waxes.

Specific examples of such waxes include, but are not limited to, natural waxes including: vegetable waxes such as carnauba wax, cotton wax, Japan wax, and rice wax; animal waxes such as bee wax and lanolin; mineral waxes such as ozokerite; and petroleum waxes such as paraffin, microcrystalline, and petrolatum. In addition to these natural waxes, synthesis hydrocarbon waxes such as Fischer-Tropsch wax and polyethylene wax and synthesis wax such as ester, ketone, and ether are also usable. Furthermore, aliphatic acid amide such as 12-hydroxystearic acid amide, stearic acid amide, phthalic acid anhydride imide, and chlorinated hydrocarbons; crystalline polymer resins having a low molecular weight such as homo polymers, for example, poly-n-stearylic methacrylate and poly-n-lauryl methacrylate, and copolymers (for example, copolymers of n-stearyl acrylate-ethylmethacrylate); and crystalline polymer having a long alkyl group in the branched chain are also usable. These can be used alone or in combination.

The melting point of the wax has no particular limit and can be suitably selected to suit to a particular application. It is preferably from 50 to 120 degrees C. and more preferably from 60 to 90 degrees C. A melting point of wax of 50 or higher degrees C. prevents an adverse impact of wax on the high temperature storage stability and a melting point of 120 or lower degrees C. prevents cold offset at low temperatures during fixing.

The melt-viscosity of wax is preferably from 5 cps to 1,000 cps and more preferably from 10 cps to 100 cps at a temperature 20 degrees C. higher than the melting point of the wax (release agent). A melt-viscosity of 5 cps or more prevents the degradation of the releasability. A melt-viscosity of 1,000 cps or less will suffice to demonstrate the hot offset resistance and low temperature fixability of a release agent.

The proportion of wax to the toner mentioned above is not particularly limited and can be suitably selected to suit to a particular application. For example, it is preferably from 0 to 40 percent by mass and more preferably from 3 to 30 percent by mass. A proportion of 40 or less percent by mass prevents the degradation of flowability of the toner.

### Crystalline Polyester Resin

The crystalline polyester resin is prepared by a polyol with a polycarboxylic acid including a polycarboxylic anhydride and polycarboxylic acid ester or their derivatives. In the present disclosure, the crystalline polyester resin refers to a substance obtained by using a polyol and a polycarboxylic acid including a polycarboxylic anhydride and polycarboxylic acid ester or their derivatives as described above. The crystalline polyester resin excludes modified polyester resin obtained by prepolymer and resin obtained by cross-linking and/or elongating the prepolymer.

### Polyhydric Alcohol

The polyhydric alcohol is not particularly limited and can be suitably selected to suit to a particular application. Examples include, but are not limited to, diol and tri- or higher alcohols. One example of diol is saturated aliphatic diol. The saturated aliphatic diols encompass straight-chain and branched-chain types, with preference given to the straight-chain variants. Particularly advantageous are the straight-chain saturated aliphatic diols with carbon numbers ranging from 2 to 12. A branched-type saturated aliphatic diol may diminish the crystallinity of the crystalline polyester resin, thereby lowering its melting point. Practical saturated aliphatic diol having 13 or more carbon atoms is not readily available.

Specific examples of the saturated aliphatic diol include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-cicosandecanediol. Of these, ethylene glycol, 1,4-butanediol, 1,6-hexanediol, 1,8-octanediol, 1,9-nonanediol, 1,10-decanediol, and 1,12-dodecanediol are preferable to enhance crystallinity of the crystalline polyester resin and achieve excellent sharp melting thereof.

Specific examples of the tri- or higher alcohol having include, but are not limited to, glycerin, trimethylol ethane, trimethylol propane, and pentaerythritol. These may be used alone or in a combination of two or more thereof.

### Polycarboxylic Acid

The polycarboxylic acid is not particularly limited and can be suitably selected to suit to a particular application. Examples include, but are not limited to, dicarboxylic acid and tri- or higher carboxylic acid.

Specific examples of dicarboxylic acids include, but are not limited to, saturated aliphatic dicarboxylic acid such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid and aromatic dicarboxylic acids such as phthalic acid, isophthalic acid, terephthalic acid, naphthalene-2,6-dicarboxylic acid, malonic acid, and mesaconic acid. They include anhydrides or lower alkylesters (1 to 3 carbon atoms) thereof.

Specific examples of the tri- or higher carboxylic acids include, but are not limited to, 1,2,4-benzene tricarboxylic acid, 1,2,5-benzene tricarboxylic acid, 1,2,4-naphtalene tricarboxylic acid, and their anhydrides or lower alkyl esters (1 to 3 carbon atoms).

These may be used alone or in a combination of two or more thereof.

The crystalline polyester resin is preferably formed of a straight chain saturated aliphatic dicarboxylic acid with 4 to 12 carbon atoms and a straight chain saturated aliphatic diol with 2 to 12 carbon atoms. This crystalline polyester resin thus demonstrates high crystallinity and excellent sharp melting, thereby achieving excellent low temperature fixability. One way of controlling the crystallinity and the softening point of the crystalline polyester resin C is to design and use a non-linear polyester obtained through polycondensation in which, during polyesterization, polyol including tri- or higher alcohol such as glycerin is added to the alcohol component and polycarboxylic acid including tri- or higher carboxylic acid such as trimellitic anhydride is added.

The molecular structure of the crystalline polyester resin in the present disclosure can be analyzed by measuring a solution or solid by methods such as NMR, X ray diffraction, GC/MS, LC/MS, and infrared (IR) absorption measuring.

The crystalline polyester resin C can be simply detected as a substance that has absorption in the range of 965±10 cm⁻¹ and 990±cm⁻¹ based on δCH (out of plane bending vibration) of olefin in an infrared absorption spectrum.

Based on the knowledge about the molecular weight that a resin having a low molecular weight and a sharp molecular weight distribution has good low temperature fixability, and a resin containing a component with a small molecular weight in a large amount has a poor high temperature storage stability, the inventors of the present invention have found that the molecular weight of the crystalline polyester resin C preferably has a peak in a range of from 3.5 to 4.0, a peak half width value of 1.5 or less, a weight average molecular weight (Mw) of from 3,000 to 30,000, a number average molecular weight (Mn) of from 1,000 to 10,000, and an Mw/Mn of from 1 to 10 in the graph of the molecular weight distribution due to gel permeation chromatography (GPC) of a portion soluble in o-dichlorobenzene with an X axis of log (M) and an Y axis of a molecular weight represented in percent by mass.

The weight average molecular weight Mw is more preferably from 5,000 to 15,000, the number average molecular weight Mn is more preferably from 2,000 to 10,000, and the ratio of Mw/Mn is more preferably from 1 to 5.

The acid value of the crystalline polyester resin is preferably 5 or more mgKOH/g to achieve a target low temperature fixability in terms of the affinity between paper and resin and more preferably 7 or more mgKOH/g to manufacture fine particles by a phase-transfer emulsification. On the other hand, it is preferably 45 or less mgKOH/g to enhance the hot offset property. The hydroxyl value of a crystalline polymer is preferably from 0 to 50 mgKOH/g and more preferably from 5 to 50 mgKOH/g to achieve a target low temperature fixability and good chargeability.

### Process e (Shell Forming)

In the shell forming process, a shell layer is formed around the aggregated particle obtained during the aggregation process.

The method of forming the shell layer is not particularly limited and can be suitably selected to suit to a particular application. For example, after producing spheroidized particles of the desired target particle diameter in a fusion process, a shell layer can be formed by adding an amorphous resin containing a polyester resin with a sulfonic acid salt group, followed by repeating the aggregation and fusion processes.

### Process f (Fusion Process)

Next, the aggregated particles with the shell layer on is fused through heat treatment to reduce surface irregularities. Fusion can be achieved by heating the liquid dispersion of particles with stirring. The temperature of the liquid is preferably around the glass transition temperature Tg of the resin being used.

### Process g (Annealing Process)

If a crystalline resin is added in the aggregation, the aggregated resin is subjected to annealing after drying to phase-separate the amorphous resin from the crystalline resin, thereby enhancing the fixability. Specifically, the resin annealed is stored at around the Tg for 10 or more hours.

### Process h (Rinsing and Drying Process)

The toner particle liquid dispersion obtained by the method described above contains auxiliary materials such as aggregated salts other than the toner particles. The liquid dispersion should be rinsed to extract the toner particles alone. A method such as centrifugation, filtering under reduced pressure, and filter pressing are employed to rinse the toner particle. The method is not particularly limited in the present disclosure. Any of the methods mentioned above obtains a cake of toner particles. Suppose more than one operation of rinsing is required. In that case, the cake obtained is repeatedly dispersed in an aqueous medium to produce a slurry and extract resin particles from the slurry by one of the above-mentioned methods. Alternatively, auxiliary materials held in colored toner particles can be rinsed by a passage of an aqueous medium through a cake if filtrating under reduced pressure or filter pressing is employed.

The aqueous medium for use in rinsing is water or a solvent mixture of water with alcohol such as methanol and ethanol. To reduce the burden on the environment, water is preferable.

Since the rinsed toner particles hold a considerable amount of water inside, the toner particles alone can be obtained by removing the aqueous medium through drying. In the drying method, it is possible to use a drier such as a spray drier, vacuum freeze drier, vacuum drier, ventilation rack drier, mobile rack drier, fluid bed drier, rotary drier, and stirring drier. The dried toner particle is preferably further dried until the moisture in the particle is less than 1 percent. The dried resin particles agglomerate softly. If this softly-aggregated particle is not convenient for use, it is suitable to pulverize it with a device such as a jet mill, Henschel mixer, super mixer, coffee mill, Oster blender, and food processor to loosen it.

### External Additive Treatment

Additives such as inorganic fine particles, fine polymer particles, and a cleaning improver can be added to or mixed with the toner particle obtained in an embodiment of the present invention to impart flowability, chargeability, and cleaning property.

Specific examples of such mixing methods include, but are not limited to, a method in which an impact is applied to a mixture with a blade rotating at a high speed and a method in which a mixture is put into a jet air to collide particles against each other or complex particles to a suitable collision plate.

Specific examples of such mechanical impact applicators include, but are not limited to, ONG MILL (available from HOSOKAWA MICRON CO., LTD.), modified I TYPE MILL (available from Nippon Pneumatic Mfg. Co., Ltd.) in which the air pressure of pulverization is reduced, HYBRIDIZATION SYSTEM (available from NARA MACHINE CO., LTD.), KRYPTRON SYSTEM (available from KAWASAKI HEAVY INDUSTRIES, LTD.), and automatic mortars.

### External Additive

The inorganic fine particle preferably has a primary particle diameter of from 5 nm to 2 μm, and more preferably from 5 nm to 500 nm. The specific surface as measured by BET method is preferably from 20 to 500 m²/g. The proportion of this inorganic fine particle to a toner is preferably from 0.01 to 5 percent by mass.

Specific examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

The fine polymer particles include, but are not limited to, polystyrene, methacrylates, and acrylates obtained by soap-free emulsion polymerization, suspension polymerization, or dispersion polymerization, and polycondensed particles such as silicone, benzoguanamine, and nylon, and polymer particles of thermocuring resin.

The external additive such as a fluidizer can be hydrophobized by surface treatment to enhance the hydrophobicity and prevent the deterioration of the fluidity and chargeability in a high humidity environment. Preferred specific examples of surface treatment agents include, but are not limited to, silane coupling agents, silyl agents, silane coupling agents having a fluorine alkyl group, organic titanate coupling agents, aluminum-based coupling agents, silicone oil, and modified-silicone oil.

Cleaning improvers remove a development agent remaining on an image bearer such as a photoconductor and a primary transfer body.

Specific examples include, but are not limited to, zinc stearate, calcium stearate and metal salts of fatty acid acids such as stearic acid and polymer fine particles such as polymethyl methacrylate fine particles and polystyrene fine particles, which are prepared by a method such as soap-free emulsion polymerization. The polymer particulates preferably have a narrow particle size distribution and the weight average particle diameter thereof is preferably from 0.01 to 1 μm.

### Developing Agent

The developing agent of the present disclosure contains at least the toner mentioned above of the present disclosure. The developing agent can be used as a single-component developing agent or a two-component developing agent mixed with carrier particles. In particular, when used with high-speed printers that correspond to the recent improvement in information processing speed, the two-component developing agent is preferable to extend its working life.

When a one-component development agent using the toner described above is used and replenished a number of times, the change in the particle diameter of the toner is small, no filming of the toner on the developing roller occurs, and no fusion bonding of the toner onto members such as a blade for regulating the thickness of the toner layer occurs. Therefore, good and stable developability is sustained to produce quality images even when the development agent is stirred for an extended period of time.

In a case of a two-component developing agent using the toner described above, extended toner replenishment over time does not significantly alter the particle size of the toner in the developing agent, which leads to excellent and stable development performance during long-term agitation in the developing device.

Furthermore, the developing agent of the present disclosure can also be used as a replenishment developing agent.

### Carrier

There is no specific limitation to the carrier and it can be suitably selected to suit to a particular application. It is preferable to use a carrier particle that has a core material and a resin layer covering the core material.

### Developing Agent Accommodating Unit

The developing agent accommodating unit for accommodating the developing agent of the present disclosure is not particularly limited and can be chosen from those known in the art. Examples include containers with a body and a cap.

The size, shape, structure, and material of the container body are not particularly limited, but a cylindrical shape is preferable.

Specifically, using a cylindrical shape with an inner circumferential surface featuring spiral-shaped irregularities, some or all of which have a bellows function, is preferable. This shape allows the developing agent, as the content, to move toward the dispensing outlet side during rotation. Additionally, the material should exhibit good dimensional accuracy. Examples of the materials include, but are not limited to, polyester resin, polyethylene resin, polypropylene resin, polystyrene resin, polyvinyl chloride resin, polyacrylic acid, polycarbonate resin component ABS resin, and polyacetal resin.

The developing agent container is easy to store and transport, and it is excellent in handling, allowing it to be detachably attached to equipment such as a process cartridge and an image forming apparatus, which are described later, facilitating the straightforward replenishment of the developing agent.

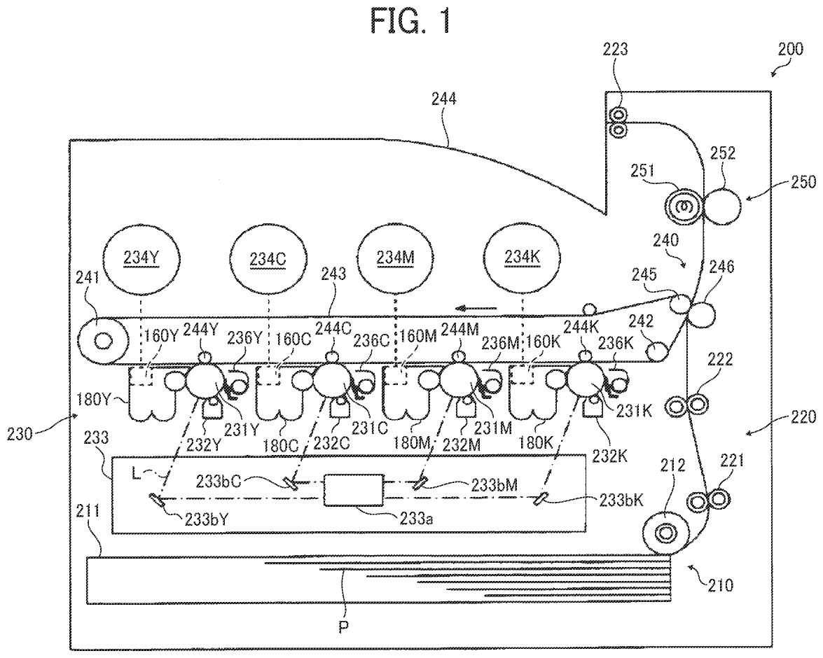

Next, an embodiment of image forming with the image forming apparatus of the present disclosure is described with reference to FIG. 1. One of the image forming apparatuses in the present embodiment is a printer. However, the image forming apparatus is not particularly limited to an apparatus such as a printer, a photocopier, a facsimile machine, or a multifunction peripheral as long as it can form images with toner.

An image forming apparatus 200 includes a sheet feeding unit 210, a conveyance unit 220, an image forming unit (latent electrostatic image forming device) 230, a transfer unit (transfer device) 240, and a fixing unit (fixing device) 250.

The sheet feeding unit 210 includes a sheet feeding cassette 211 on which sheets to be fed are piled and a feeding roller 212 that feeds a sheet (recording medium) P piled on the sheet feeding cassette 211 one by one.

The conveyance unit 220 includes a roller 221 for conveying the sheet P fed by the feeding roller 212 toward the transfer unit 240, a pair of timing rollers 222 for pinching the front end of the sheet P conveyed by the roller 221 on standby and sending out the sheet P to the transfer unit 240 at a particular timing, and ejection rollers 223 for ejecting the sheet P on which toner is fixed by the fixing unit 250 to an ejection tray 224.

The image forming part 230 includes an image forming unit (latent electrostatic image bearer) 234Y that forms an image using a developing agent containing yellow toner, an image forming unit 234C that forms an image using a developing agent containing cyan toner, an image forming unit 234M that forms an image using a developing agent containing magenta toner, and an image forming unit 234K that forms an image using a developing agent containing black toner, sequentially standing from left to right in the drawing with a particular interval. The image forming part 230 also includes a charger 232 (232Y, 232M. 232C. 232K) and an irradiator 233 that emits beams of light L. The irradiator 233 includes a light source 233a and a polygon mirror 233b (233bY, 233bM, 233bC, 233bK) that redirects the beams of light L to the charger 232.

An arbitrary image forming unit of the image forming units 234Y, 234C, 234M, and 234K is referred to as an image forming unit.

In addition, the developing agent contains toner and carrier. The four image forming units have substantially the same structure except for the individual developing agents used for respective image forming units.

The transfer unit 240 includes a driving roller 241, a driven roller 242, an intermediate transfer belt 243 disposed rotatable counterclockwise in the drawing in accordance with the drive of the driving roller 241, a primary transfer roller (244Y, 244C, 244M, and 244K) disposed facing the drum photoconductor (latent electrostatic image bearer) 231 with the intermediate transfer belt 243 therebetween, and a secondary facing roller 245 and a secondary transfer roller 246 disposed facing each other at the point of the toner image transferred to the sheet P with the intermediate transfer belt 243 therebetween.

A fixing device 250 with a heater inside includes a fixing belt 251 for heating the sheet P and a pressing roller 252 for forming a nip with the fixing belt 251 by rotatably pressing it. Heat is applied with pressure to the color toner image on the sheet P at the nipping portion, thereby fixing the color toner image. The sheet P on which the color toner image is fixed is ejected to the ejection tray 224 by the ejection rollers 223, which completes a series of image forming process.

### Process Cartridge

The process cartridge relating to the present disclosure is made to be detachably attachable to an image forming apparatus. It includes at least a latent electrostatic image bearer and a developing device that renders the latent electrostatic image visible with a developing agent containing the toner of the present disclosure to form a toner image. The process cartridge of the present disclosure may furthermore include other optional devices.

The developing device includes at least a developing agent container that contains a developing agent and a developing agent bearer that bears and conveys the developing agent in the developing agent container. The developing device may furthermore optionally include a regulating member for regulating the thickness of the developing agent borne on the bearer.

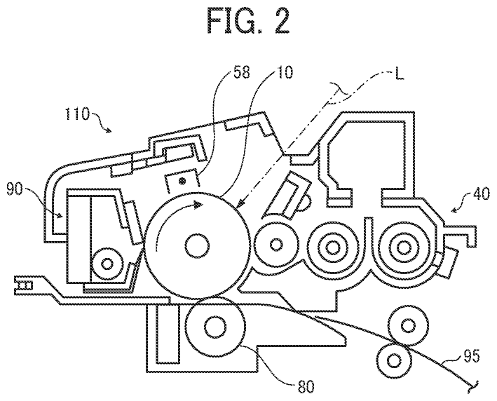

FIG. 2 is a diagram illustrating an example of the process cartridge relating to the present disclosure. The process cartridge 110 includes a drum photoconductor (latent electrostatic image bearer) 10, a corona charger 58, a developing device 40, a transfer roller 80, a cleaner 90, and a recording medium 95.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto. The terms “part” and “percent” respectively refer to part by mass and percent by mass.

### Synthesis of Amorphous Polyester Resin A-1

A mixture of an adduct of bisphenol A with 2 mols of ethylene oxide, an adduct of bisphenol A with 3 mols of propylene oxide, flake-like recycle PET (ethylene glycol unit inside), and biomass-derived propylene glycol with a molar ratio at 20:30:28:22 and a molar ratio of flake-like recycle PET (ethylene glycol unit inside) to adipic acid at 62:38 was placed in a four-necked flask equipped with a nitrogen introducing tube, a dehydration tube, a stirrer, and a thermocouple to achieve a molar ratio (OH/COOH) of hydroxyl group to carboxyl group at 1:1.3. The mixture was allowed to react with titanium tetraisopropoxide (500 ppm to resin component) at normal pressure and 230 degrees C. for 8 hours, followed by another 4-hour reaction under reduced pressure of 10 to 15 mmHg. Then trimellitic anhydride was placed in the reaction container to achieve a proportion of 1 mol percent to the entire resin component followed by a 3-hour reaction at 18 degrees C. under normal pressure, thus obtaining Amorphous Polyester Resin A-1.

### Synthesis of Amorphous Polyester Resin A-2

A mixture of an adduct of bisphenol A with 2 mols of ethylene oxide, an adduct of bisphenol A with 3 mols of propylene oxide, flake-like recycle PET (ethylene glycol unit inside), and biomass-derived propylene glycol with a molar ratio at 20:30:10:40 and a molar ratio of flake-like recycle PET (ethylene glycol unit inside) to adipic acid at 62:38 was placed in a four-necked flask equipped with a nitrogen introducing tube, a dehydration tube, a stirrer, and a thermocouple to achieve a molar ratio (OH/COOH) of hydroxyl group to carboxyl group at 1:1.3. The mixture was allowed to react with titanium tetraisopropoxide (500 ppm to resin component) at normal pressure and 230 degrees C. for 8 hours, followed by another 4-hour reaction under reduced pressure of 10 to 15 mmHg. Then trimellitic anhydride was placed in the reaction container to achieve a proportion of 1 mol percent to the entire resin component followed by a 3-hour reaction at 18 degrees C. under normal pressure, thus obtaining Amorphous Polyester Resin A-2.

### Synthesis of Amorphous Polyester Resin A-3

A mixture of an adduct of bisphenol A with 2 mols of ethylene oxide, an adduct of bisphenol A with 3 mols of propylene oxide, flake-like recycle PET (ethylene glycol unit inside), and biomass-derived propylene glycol with a molar ratio at 20:30:0:50 and a molar ratio of flake-like recycle PET (ethylene glycol unit inside) to adipic acid at 62:38 was placed in a four-necked flask equipped with a nitrogen introducing tube, a dehydration tube, a stirrer, and a thermocouple to achieve a molar ratio (OH/COOH) of hydroxyl group to carboxyl group at 1:1.3. The mixture was allowed to react with titanium tetraisopropoxide (500 ppm to resin component) at normal pressure and 230 degrees C. for 8 hours, followed by another 4-hour reaction under reduced pressure of 0 to 15 mmHg. Then trimellitic anhydride was placed in the reaction container to achieve a proportion of 1 mol percent to the entire resin component followed by a 3-hour reaction at 18 degrees C. under normal pressure, thus obtaining Amorphous Polyester Resin A-3.

### Synthesis of Amorphous Polyester Resin A-4

A mixture of an adduct of bisphenol A with 2 mols of ethylene oxide, an adduct of bisphenol A with 3 mols of propylene oxide, flake-like recycle PET (ethylene glycol unit inside), and biomass-derived propylene glycol with a molar ratio at 15:25:36:24 and a molar ratio of flake-like recycle PET (ethylene glycol unit inside) to adipic acid at 60:40 was placed in a four-necked flask equipped with a nitrogen introducing tube, a dehydration tube, a stirrer, and a thermocouple to achieve a molar ratio (OH/COOH) of hydroxyl group to carboxyl group at 1:1.3. The mixture was allowed to react with titanium tetraisopropoxide (500 ppm to resin component) at normal pressure and 230 degrees C. for 8 hours, followed by another 4-hour reaction under reduced pressure of 10 to 15 mmHg. Then trimellitic anhydride was placed in the reaction container to achieve a proportion of 1 mol percent to the entire resin component followed by a 3-hour reaction at 18 degrees C. under normal pressure, thus obtaining Amorphous Polyester Resin A-4.

### Synthesis of Amorphous Polyester Resin A-5

A mixture of an adduct of bisphenol A with 2 mols of ethylene oxide, an adduct of bisphenol A with 3 mols of propylene oxide, flake-like recycle PET (ethylene glycol unit inside), and biomass-derived propylene glycol with a molar ratio at 5:10:49:36 and a molar ratio of flake-like recycle PET (ethylene glycol unit inside) to adipic acid at 91:9 was placed in a four-necked flask equipped with a nitrogen introducing tube, a dehydration tube, a stirrer, and a thermocouple to achieve a molar ratio (OH/COOH) of hydroxyl group to carboxyl group at 1:1.3. The mixture was allowed to react with titanium tetraisopropoxide (500 ppm to resin component) at normal pressure and 230 degrees C. for 8 hours, followed by another 4-hour reaction under reduced pressure of 10 to 15 mmHg. Then trimellitic anhydride was placed in the reaction container to achieve a proportion of 1 mol percent to the entire resin component followed by a 3-hour reaction at 18 degrees C. under normal pressure, thus obtaining Amorphous Polyester Resin A-5.

### Synthesis of Amorphous Polyester Resin A-6

A mixture of an adduct of bisphenol A with 2 mols of ethylene oxide, an adduct of bisphenol A with 3 mols of propylene oxide, flake-like recycle PET (ethylene glycol unit inside), and biomass-derived propylene glycol with a molar ratio at 0:0:62:38 and a molar ratio of flake-like recycle PET (ethylene glycol unit inside) to adipic acid at 88:12 was placed in a four-necked flask equipped with a nitrogen introducing tube, a dehydration tube, a stirrer, and a thermocouple to achieve a molar ratio (OH/COOH) of hydroxyl group to carboxyl group at 1:1.3. The mixture was allowed to react with titanium tetraisopropoxide (500 ppm to resin component) at normal pressure and 230 degrees C. for 8 hours, followed by another 4-hour reaction under reduced pressure of 10 to 15 mmHg. Then trimellitic anhydride was placed in the reaction container to achieve a proportion of 1 mol percent to the entire resin component followed by a 3-hour reaction at 18 degrees C. under normal pressure, thus obtaining Amorphous Polyester Resin A-6.

### Synthesis of Amorphous Polyester Resin A-7

A mixture of an adduct of bisphenol A with 2 mols of ethylene oxide, an adduct of bisphenol A with 3 mols of propylene oxide, flake-like recycle PET (ethylene glycol unit inside), and biomass-derived propylene glycol with a molar ratio at 0:0:10:90 and a molar ratio of flake-like recycle PET (ethylene glycol unit inside) to adipic acid at 12:88 was placed in a four-necked flask equipped with a nitrogen introducing tube, a dehydration tube, a stirrer, and a thermocouple to achieve a molar ratio (OH/COOH) of hydroxyl group to carboxyl group at 1:1.3. The mixture was allowed to react with titanium tetraisopropoxide (500 ppm to resin component) at normal pressure and 230 degrees C. for 8 hours, followed by another 4-hour reaction under reduced pressure of 10 to 15 mmHg. Then trimellitic anhydride was placed in the reaction container to achieve a proportion of 1 mol percent to the entire resin component followed by a 3-hour reaction at 18 degrees C. under normal pressure, thus obtaining Amorphous Polyester Resin A-7.

### Synthesis of Amorphous Polyester Resin A-8

A mixture of an adduct of bisphenol A with 2 mols of ethylene oxide, an adduct of bisphenol A with 3 mols of propylene oxide, flake-like recycle PET (ethylene glycol unit inside), and biomass-derived propylene glycol with a molar ratio at 5:10:23:62 and a molar ratio of flake-like recycle PET (ethylene glycol unit inside) to adipic acid at 27:73 was placed in a four-necked flask equipped with a nitrogen introducing tube, a dehydration tube, a stirrer, and a thermocouple to achieve a molar ratio (OH/COOH) of hydroxyl group to carboxyl group at 1:1.3. The mixture was allowed to react with titanium tetraisopropoxide (500 ppm to resin component) at normal pressure and 230 degrees C. for 8 hours, followed by another 4-hour reaction under reduced pressure of 10 to 15 mmHg. Then trimellitic anhydride was placed in the reaction container to achieve a proportion of 1 mol percent to the entire resin component followed by a 3-hour reaction at 8 degrees C. under normal pressure, thus obtaining Amorphous Polyester Resin A-8.

The raw material proportions of Amorphous Polyester Resin A-1 to Amorphous Polyester Resin A-8 obtained above are shown in Table 1.

TABLE 1

| | Alcohol monomer | | | | |
|---|---|---|---|---|---|
| | Adduct of | Adduct of | | | |
| | bisphenol A | bisphenol A | | | |
| | with 2 mols | with 3 mols | Eth- | | |
| | of ethylene | of propylene | ylene | Propylene | |
| Amorphous | oxide | oxide | glycol | glycol | Total |
| polyester | mol | mol | mol | mol | mol |
| resin No. | percent | percent | percent | percent | percent |
| A-1 | 20 | 30 | 28 | 22 | 100 |
| A-2 | 20 | 30 | 10 | 40 | 100 |
| A-3 | 20 | 30 | 0 | 50 | 100 |
| A-4 | 15 | 25 | 36 | 24 | 100 |
| A-5 | 5 | 10 | 49 | 36 | 100 |
| A-6 | 0 | 0 | 62 | 38 | 100 |
| A-7 | 0 | 0 | 10 | 90 | 100 |
| A-8 | 5 | 10 | 23 | 62 | 100 |

| | Acid monomer | | | |
|---|---|---|---|---|
| | Terephthalic | Adipic | | Total of |
| Amorphous | acid | acid | Total | monomer |
| polyester | mol | mol | mol | mol |
| resin No. | percent | percent | percent | percent |
| A-1 | 62 | 38 | 100 | 200 |
| A-2 | 62 | 38 | 100 | 200 |
| A-3 | 62 | 38 | 100 | 200 |
| A-4 | 60 | 40 | 100 | 200 |
| A-5 | 91 | 9 | 100 | 200 |
| A-6 | 88 | 12 | 100 | 200 |
| A-7 | 12 | 88 | 100 | 200 |
| A-8 | 27 | 73 | 100 | 200 |

### Synthesis of Prepolymer

Into a reaction vessel equipped with a cooling tube, a stirrer, and a nitrogen introduction pipe, 3-methyl-1,5-pentanediol, isophthalic acid, and plant-derived sebacic acid were introduced along with titanium tetraisopropoxide (at 1,000 ppm relative to the resin component) to achieve a molar ratio of hydroxyl groups to carboxyl groups (OH/COOH) of 1:1.1. The composition was consisted of 100 mol percent 3-methyl-1,5-pentanediol for the diol components, with the dicarboxylic acid components comprising 66 mol percent isophthalic acid and 34 mol percent sebacic acid. Additionally, the content of trimethylolpropane in the entire monomers was adjusted to 1.5 mol percent. Subsequently, the temperature was raised to 200 degrees C. over approximately 4 hours and then to 230 degrees C. over 2 hours, which allowed reaction to proceed until the effluent water ceased. Further, the reaction was conducted for 5 hours under reduced pressure of 10 to 15 mmHg to obtain Intermediate Polyester.

Next, Intermediate Polyester obtained and isophorone diisocyanate (IPDI) were introduced into a reaction vessel equipped with a cooling tube, a stirrer, and a nitrogen introduction pipe at a molar ratio (isocyanate groups of IPDI/hydroxyl groups of Intermediate Polyester) of 2.0. After dilution with ethyl acetate to form a 50 percent ethyl acetate solution, the resulting mixture was allowed to react at 100 degrees C. for 5 hours, thereby obtaining Prepolymer.

### Synthesis of Crystalline Polyester Resin

Plant-derived sebacic acid and 1,6-hexane diol were placed in a 5 L four-necked flask equipped with a nitrogen introducing tube, a dehydration tube, a stirrer, and a thermocouple to achieve a molar ratio of hydroxyl group to carboxyl group, OH/COOH at 0.9:1. Then the mixture was allowed to react together with titanium tetraisopropoxide (500 ppm to the resin portion) at 180 degrees C. for ten hours, followed by a 3-hour reaction at temperature raised to 200 degrees C. and a 2-hour reaction under a pressure of 8.3 kPa to obtain Crystalline Polyester Resin 1.

### Preparation of Master Batch (MB)

A total of 1,200 parts of water, 500 parts of carbon black (Printex 35, DBP oil absorption amount of 42 ml/100 mg, PH of 9.5, available from Degussa AG), and 500 parts of Amorphous Polyester Resin A-1 ? were admixed in a Henschel Mixer (available from NIPPON COKE & ENGINEERING. CO., LTD.). The mixture was kneaded at 150 degrees C. for 30 minutes using two rolls and rolled and cooled down followed by pulverization with a pulverizer to obtain Master Batch 1.

### Preparation of Liquid Dispersion of Wax

A total of 42 parts of carnauba wax (RN-5, plant-based wax, melting point of 82 degrees C., available from CERARICA NODA Co., Ltd.) as a release agent and 420 parts of ethyl acetate were placed in a container equipped with a stirrer and a thermometer.

The temperature was raised to 80 degrees C. under stirring, held at 80 degrees Celsius for 5 hours, then lowered to 30 degrees C. over the course of 1 hour. The resulting mixture was then dispersed using a bead mill (ULTRA VISCOMILL, available from by AIMEX) under the conditions of a liquid transfer speed of 1 kg/hour, a disk peripheral speed of 6 m/s, and a 80 volume percent filling with zirconia beads with a diameter of 0.5 mm for 3 passes to obtain Liquid Dispersion 1 of Wax. Its average particle diameter was 400 nm while its concentration of the solid portion was 40 percent.

### Preparation of Liquid Dispersion of Crystalline Polyester Resin

In a vessel equipped with a stirrer and a thermometer, 308 parts of Crystalline Polyester Resin 1 and 1,900 parts of ethyl acetate were charged. Next, the temperature was raised to 80 degrees C. and held for 5 hours under stirring, followed by lowering it to 30 degrees C. over a period of 1 hour. Furthermore, using an Ultra-Visco Mill bead mill (available from AIMEX CO., Ltd.), zirconia beads with a diameter of 0.5 mm were filled to 80 percent by volume and dispersed under the condition of three passes to obtain Liquid Dispersion 1 of Crystalline Polyester Resin. The volume average particle diameter was 450 nm, and the solids concentration was 10 percent.

### Manufacturing Example of Sulfonic Acid Salt Group-Containing Resin S1

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of flake-like recycled PET (ethylene glycol unit inside), 10 parts of biomass-derived glycerol, 100 parts of flake-like recycled PET (terephthalic acid unit inside), 22 parts of biomass-derived succinic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S1.

### Manufacturing Example of Sulfonic Acid Salt Group-Containing Resin S2

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of flake-like recycled PET (ethylene glycol unit inside), 18 parts of biomass-derived glycerol, 76 parts of flake-like recycled PET (terephthalic acid unit inside), 40 parts of biomass-derived succinic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under reduced pressure of 5 mmHg to 20 mmHg to obtain Sulfonic Acid Salt Group-containing Resin S2.

### Manufacturing Example of Sulfonic Acid Salt Group-Containing Resin S3

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 29 parts of flake-like recycled PET (ethylene glycol unit inside), 28 parts of biomass-derived glycerol, 60 parts of flake-like recycled PET (terephthalic acid unit inside), 45 parts of biomass-derived succinic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under reduced pressure of 5 mmHg to 20 mmHg to obtain Sulfonic Acid Salt Group-containing Resin S3.

### Manufacturing Example of Sulfonic Acid Salt Group-Containing Resin S4

Into a 5 L four-neck flask equipped with a nitrogen introducing tube, a dehydration tube, a stirrer, and a thermocouple, 22 parts of an adduct of bisphenol A with 5 mols of ethylene oxide, 492 parts of an adduct of bisphenol A with 5 mols of propylene oxide, 88 parts of adipic acid, 81 parts of dodecanoic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S4.

### Manufacturing Example of Sulfonic Acid Salt Group-Containing Resin S5

Into a 5 L four-neck flask equipped with a nitrogen introducing tube, a dehydration tube, a stirrer, and a thermocouple, 22 parts of an adduct of bisphenol A with 5 mols of ethylene oxide, 492 parts of an adduct of bisphenol A with 5 mols of propylene oxide, 17 parts of flake-like recycled PET (terephthalic acid unit inside), 124 parts of adipic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S5.

### Manufacturing Example of Sulfonic Acid Salt Group-Containing Resin S6

Into a 5 L four-neck flask equipped with a nitrogen introducing tube, a dehydration tube, a stirrer, and a thermocouple, 122 parts of an adduct of bisphenol A with 2 mols of ethylene oxide, 199 parts of an adduct of bisphenol A with 2 mols of propylene oxide, 133 parts of flake-like recycled PET (terephthalic acid unit inside), 22 parts of adipic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S6.

### Manufacturing Example of Sulfonic Acid Salt Group-Containing Resin S7

Into a 5 L four-neck flask equipped with a nitrogen introducing tube, a dehydration tube, a stirrer, and a thermocouple, 50 parts of flake-like recycled PET (ethylene glycol unit inside), 18 parts of biomass-derived glycerol, 96 parts of flake-like recycled PET (terephthalic acid unit inside), 12 parts of fumaric acid, 57 parts of anhydrous trimellitic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S7.

### Manufacturing Example of Sulfonic Acid Salt Group-Containing Resin S8

Into a 5 L four-neck flask equipped with a nitrogen introducing tube, a dehydration tube, a stirrer, and a thermocouple, 22 parts of flake-like recycled PET (ethylene glycol unit inside), 18 parts of biomass-derived glycerol, 80 parts of flake-like recycled PET (terephthalic acid unit inside), 99 parts of anhydrous trimellitic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S8.

### Manufacturing Example of Sulfonic Acid Salt Group-Containing Resin S9

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of biomass-derived succinic acid, and 2.5 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S9.

### Manufacturing Example of Sulfonic Acid Salt Group-Containing Resin S10

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of flake-like recycled PET (ethylene glycol unit inside), 10 parts of biomass-derived propylene glycol, 100 parts of flake-like recycled PET (terephthalic acid unit inside), 22 parts of biomass-derived succinic acid, and 4.9 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S10.

### Manufacturing Example of Sulfonic Acid Salt Group-Containing Resin S11

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of biomass-derived succinic acid, and 9.8 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S11.

### Manufacturing Example of Sulfonic Acid Salt Group-Containing Resin S12

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of flake-like recycled PET (ethylene glycol unit inside), 10 parts of biomass-derived propylene glycol, 100 parts of flake-like recycled PET (terephthalic acid unit inside), 22 parts of biomass-derived succinic acid, and 19.6 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S12.

### Manufacturing Example of Sulfonic Acid Salt Group-Containing Resin S13

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of biomass-derived succinic acid, and 24.5 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S13.

### Manufacturing Example of Sulfonic Acid Salt Group-Containing Resin S14

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of flake-like recycled PET (ethylene glycol unit inside), 10 parts of biomass-derived propylene glycol, 100 parts of flake-like recycled PET (terephthalic acid unit inside), 22 parts of biomass-derived succinic acid, and 27.0 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S14.

### Manufacturing Example of Sulfonic Acid Salt Group-Containing Resin S15

Into a 5 L four-neck flask equipped with a nitrogen introducing tube, a dehydration tube, a stirrer, and a thermocouple, 35 parts of an adduct of bisphenol A with 2 mols of ethylene oxide, 79 parts of an adduct of bisphenol A with 2 mols of propylene oxide, 51 parts of flake-like recycled PET (ethylene glycol unit inside), 16 parts of biomass-derived of biomass-derived succinic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S15.

### Manufacturing Example of Sulfonic Acid Salt Group-Containing Resin S16

Into a 5 L four-neck flask equipped with a nitrogen introducing tube, a dehydration tube, a stirrer, and a thermocouple, 85 parts of flake-like recycled PET (ethylene glycol unit inside), 46 parts of biomass-derived glycerol, 99 parts of flake-like recycled PET (terephthalic acid unit inside), 9 parts of fumaric acid, 10 parts of anhydrous trimellitic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S16.

### Manufacturing Example of Sulfonic Acid Salt Group-Containing Resin S17

Into a 5 L four-neck flask equipped with a nitrogen introducing tube, a dehydration tube, a stirrer, and a thermocouple, 85 parts of flake-like recycled PET (ethylene glycol unit inside), 46 parts of biomass-derived glycerol, 99 parts of flake-like recycled PET (terephthalic acid unit inside), 2 parts of anhydrous trimellitic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S17.

### Manufacturing Example of Sulfonic Acid Salt Group-Containing Resin S18

Into a 5 L four-neck flask equipped with a nitrogen introducing tube, a dehydration tube, a stirrer, and a thermocouple, 95 parts of an adduct of bisphenol A with 2 mols of ethylene oxide, 155 parts of an adduct of bisphenol A with 2 mols of propylene oxide, 27 parts of flake-like recycled PET (ethylene glycol unit inside), 138 parts of biomass-derived propylene glycol, 40 parts of flake-like recycled PET (terephthalic acid unit inside), 130 parts of biomass-derived succinic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours.

Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S18.

### Manufacturing Example of Sulfonic Acid Salt Group-Containing Resin S19

Into a 5 L four-neck flask equipped with a nitrogen introducing tube, a dehydration tube, a stirrer, and a thermocouple, 55 parts of an adduct of bisphenol A with 2 mols of ethylene oxide, 100 parts of an adduct of bisphenol A with 2 mols of propylene oxide, 56 parts of flake-like recycled PET (ethylene glycol unit inside), 57 parts of biomass-derived propylene glycol, 40 parts of flake-like recycled PET (terephthalic acid unit inside), 60 parts of biomass-derived succinic acid, and 12.3 parts of sodium 5-sulfoisophthalate were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S19.

### Manufacturing Example of Sulfonic Acid Salt Group-Containing Resin S20

Into a 5 L four-neck flask equipped with a nitrogen introducing tube, a dehydration tube, a stirrer, and a thermocouple, 35 parts of an adduct of bisphenol A with 2 mols of ethylene oxide, 80 parts of an adduct of bisphenol A with 2 mols of propylene oxide, 30 parts of flake-like recycled PET (ethylene glycol unit inside), 10 parts of biomass-derived propylene glycol, 100 parts of flake-like recycled PET (terephthalic acid unit inside), and 22 parts of biomass-derived succinic acid were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S20.

### Manufacturing Example of Sulfonic Acid Salt Group-Containing Resin S21

Into a 5 L four-neck flask equipped with a nitrogen introducing tube, a dehydration tube, a stirrer, and a thermocouple, 95 parts of an adduct of bisphenol A with 2 mols of ethylene oxide, 155 parts of an adduct of bisphenol A with 2 mols of propylene oxide, 27 parts of flake-like recycled PET (ethylene glycol unit inside), 138 parts of biomass-derived propylene glycol, 40 parts of flake-like recycled PET (terephthalic acid unit inside), 12.3 parts of adipic acid, and 130 parts of biomass-derived succinic acid were charged. Orthotitanic acid tetra-n-butyl was added as a condensation catalyst at 1,000 ppm to the entire monomer content. The mixture was then heated to 230 degrees C. over 2 hours in a nitrogen atmosphere, and the generated water was removed while the reaction was allowed to proceed for 5 hours. Subsequently, the reaction was conducted for 4 hours under reduced pressure of 5 mmHg to 15 mmHg, followed by cooling down to 180 degrees C. After the cooling, 0.21 parts of anhydrous trimellitic acid and 200 ppm of orthotitanic acid tetra-n-butyl to the entire monomer content were added, followed by one-hour reaction at 180 degrees C. under atmospheric pressure. Then the reaction was allowed to continue for an additional 3 hours under a reduced pressure of 5 mmHg to 20 mmHg to obtain Sulfonic Acid Salt Group-containing Resin S21.

The raw material recipes of Sulfonic Acid Salt Group-containing Resin S1 to Sulfonic Acid Salt Group-containing Resin S21 obtained as above are shown in Table 2.

TABLE 2

Alcohol monomer

| | Adduct of | Adduct of | Adduct of | Adduct of |
|---|---|---|---|---|
| | bisphenol | bisphenol | bisphenol | bisphenol |
| Sulfonic | A with 2 | A with 5 | A with 2 | A with 5 |
| acid salt | mols of | mols of | mols of | mols of |
| group- | ethylene | ethylene | propylene | propylene |
| containing | oxide | oxide | oxide | oxide |
| resin No. | Part | Part | Part | Part |
| S1 | 35 | | 80 | |
| S2 | 35 | | 80 | |
| S3 | 35 | | 80 | |
| S4 | | 22 | | 492 |
| S5 | | 22 | | 492 |
| S6 | 122 | | 199 | |
| S7 | | | | |
| S8 | | | | |
| S9 | 35 | | 80 | |
| S10 | 35 | | 80 | |
| S11 | 35 | | 80 | |
| S12 | 35 | | 80 | |
| S13 | 35 | | 80 | |
| S14 | 35 | | 80 | |
| S15 | 35 | | 79 | |
| S16 | | | | |
| S17 | | | | |
| S18 | 95 | | 155 | |
| S19 | 55 | | 100 | |
| S20 | 35 | | 80 | |
| S21 | 95 | | 155 | |

| | |
|---|---|
| Sulfonic | |
| acid salt | Alcohol monomer |

| group- | Ethylene | Propylene | | Total of |
|---|---|---|---|---|
| containing | glycol | glycol | Glycerol | number |
| resin No. | Part | Part | Part | of parts |
| S1 | 30 | 10 | | 155 |
| S2 | 30 | 18 | | 163 |
| S3 | 29 | 28 | | 172 |
| S4 | | | | 514 |
| S5 | | | | 514 |
| S6 | | | | 321 |
| S7 | 50 | | 18 | 68 |
| S8 | 22 | | 18 | 40 |
| S9 | 30 | 10 | | 155 |
| S10 | 30 | 10 | | 155 |
| S11 | 30 | 10 | | 155 |
| S12 | 30 | 10 | | 155 |
| S13 | 30 | 10 | | 155 |
| S14 | 30 | 10 | | 155 |
| S15 | 51 | 16 | | 181 |
| S16 | 85 | | 46 | 131 |
| S17 | 85 | | 46 | 131 |
| S18 | 27 | 138 | | 415 |
| S19 | 56 | 57 | | 268 |
| S20 | 30 | 10 | | 155 |
| S21 | 27 | 138 | | 415 |

| Sulfonic | Acid monomer | | | | |
|---|---|---|---|---|---|
| acid salt | | | | | Anhydrous |
| group- | Terephthalic | Adipic | Succinic | Fumaric | trimellitic |
| containing | acid | acid | acid | acid | acid |
| resin No. | Part | Part | Part | Part | Part |
| S1 | 100.0 | | 22.0 | | |
| S2 | 76.0 | | 40.0 | | |
| S3 | 60.0 | | 45.0 | | |
| S4 | | 88.0 | | | |
| S5 | 17.0 | 124.0 | | | |
| S6 | 133.0 | 22.0 | | | |
| S7 | 96.0 | | | 12.0 | 57.0 |
| S8 | 80.0 | | | | 99.0 |
| S9 | 100.0 | | 22.0 | | |
| S10 | 100.0 | | 22.0 | | |
| S11 | 100.0 | | 22.0 | | |
| S12 | 100.0 | | 22.0 | | |
| S13 | 100.0 | | 22.0 | | |
| S14 | 100.0 | | 22.0 | | |
| S15 | 100.0 | | 22.0 | | |
| S16 | 99.0 | | | 9.0 | 10.0 |
| S17 | 99.0 | | | | 2.0 |
| S18 | 40.0 | | 130.0 | | |
| S19 | 40.0 | | 60.0 | | |
| S20 | 100.0 | | 22.0 | | |
| S21 | 40.0 | 12.3 | 130.0 | | |

| Sulfonic | | | | |
|---|---|---|---|---|
| acid salt | Acid monomer | | | |
| group- | Dodecanoic | Sodium 5- | Total of | Total of |
| containing | acid | sulfoisophtalate | number | number |
| resin No. | Part | Part | of parts | of parts |
| S1 | | 12.3 | 134.3 | 289.3 |
| S2 | | 12.3 | 128.3 | 291.3 |
| S3 | | 12.3 | 117.3 | 289.3 |
| S4 | 81.0 | 12.3 | 181.3 | 695.3 |
| S5 | | 12.3 | 153.3 | 667.3 |
| S6 | | 12.3 | 167.3 | 488.3 |
| S7 | | 12.3 | 177.3 | 245.3 |
| S8 | | 12.3 | 191.3 | 231.3 |
| S9 | | 2.5 | 124.5 | 279.5 |
| S10 | | 4.9 | 126.9 | 281.9 |
| S11 | | 9.8 | 131.8 | 286.8 |
| S12 | | 19.6 | 141.6 | 296.6 |
| S13 | | 24.5 | 146.5 | 301.5 |
| S14 | | 27.0 | 149.0 | 304.0 |
| S15 | | 12.3 | 134.3 | 315.3 |
| S16 | | 12.3 | 130.3 | 261.3 |
| S17 | | 12.3 | 113.3 | 244.3 |
| S18 | | 12.3 | 182.3 | 597.3 |
| S19 | | 12.3 | 112.3 | 380.3 |
| S20 | | | 122.0 | 277.0 |
| S21 | | | 182.3 | 597.3 |

### Example 1

### Preparation of Oil Phase 1

A total of 185 parts of Liquid Dispersion 1 of Wax, 190 parts of Amorphous Polyester Resin A-1, 230 parts of Liquid Dispersion 1 of Crystalline Polyester Resin, 55 parts of ethyl acetate, and 85 parts of Master Batch 1 were admixed and stirred to dissolve and disperse. Under stirring, 5 parts of ethyl acetate and 30 parts of a 10 percent sodium hydroxide aqueous solution were added to obtain Oil Phase 1. The oil phase obtained had a solid portion of 50 percent.

### Preparation of Aqueous Phase 1

A mixture of 1,150 parts of deionized water, 105 parts of ethyl acetate, and 20 parts of surfactant (sodium dodecyl sulfate) was stirred and mixed to obtain a milky white Aqueous Phase 1.

### Preparation of Core Emulsion 1

Aqueous Phase 1 was gradually added to Oil Phase 1 to conduct phase inversion emulsification. Subsequently, the resulting emulsion was purged of the solvent to obtain Core Emulsion 1.

### Preparation of Shell Emulsion 1

### Preparation of Shell Resin Solution 1

A total of 200 parts of Sulfonic Acid Salt Group-containing Resin S1 and 200 parts of methylethyl ketone were placed in a container followed by mixing with a TK HOMOMIXER, available from PRIMIX Corporation, at 5,000 rpm for 60 minutes to obtain Shell Resin Solution 1. The oil phase obtained had a solid portion of 50 percent.

### Preparation of Shell Aqueous Phase 1

A total of 468 parts of deionized water and 132 parts of methylethyl ketone were mixed and stirred to obtain Shell Aqueous Phase 1.

### Preparation of Shell Emulsion 1

A total of 5.9 parts of 28 percent ammonium water was added to 400 parts of Shell Resin Solution 1 under stirring in a TK Homomixer at 8,000 rpm. After ten minutes of mixing, 600 parts of Shell Aqueous Phase 1 was slowly added to the mixture to conduct phase inversion emulsification. Subsequently, the resulting emulsion was purged of the solvent to obtain Shell Emulsion 1.

### Processes of Aggregation and Shell Forming

A total of 170 parts of Core Emulsion 1 and 230 parts of deionized water were placed in a vessel followed by five-minutes of stirring. Next, 8 parts of a 20 percent magnesium sulfate solution were added dropwise followed by five-minutes of stirring and the temperature was then raised to 50 degrees C. When the particle diameter reached 5.0 μm, 84 parts of a 10 percent aqueous solution of [Shell Emulsion 1] were added. Following this, 9 parts of a 20 percent magnesium sulfate solution were added dropwise, and the mixture was stirred for another 10 minutes. Subsequently, the temperature was raised to 65 degrees C. and stirred for 30 minutes.

### Processes of Ceasing and Fusing

Then 41 parts of 20 percent sodium sulfate solution was added and the temperature was raised to 70 degrees C. When the particles achieved a desired circularity of 0.960 to 0.970, they were cooled to obtain Slurry Dispersion 1.

### Processes of Annealing, Rinsing, and Drying

Slurry Dispersion 1 was stored at 45 degrees C. for 10 hours followed by filtering with a reduced pressure and rinsing and drying in the following manner.

(1): A total of 100 parts of deionized water was added to the filtered cake, mixed using a TK Homomixer at 12,000 rpm for 10 minutes, and subsequently filtered.

(2): A total of 900 parts of deionized water was admixed with the filtered cake obtained in (1) using a TK homomixer at 12,000 rpm for 30 minutes under ultrasonic vibration, and filtered with a reduced pressure.

This process was repeated for the re-slurry liquid until the electrical conductivity of the filtrate reached 10 μS/cm, followed by filtration to obtain Filter Cake 1.

(3): Filtered Cake 1 was dried in a circulating air dryer at 45 degrees C. for 48 hours and sieved through a 75 μm mesh sieve, resulting in formation of Resin Particle 1.

Treatment with External Additive

A total of 2.0 parts of hydrophobic silica (HDK-2000, available from Clariant AG) was admixed with 100 parts of Resin Particle 1 in a Henschel Mixer and filtered with a screen having an opening of 500 meshes to obtain Toner 1.

Shell Emulsion 2 to Shell Emulsion 21 were prepared in the same manner as in Preparation of Shell Emulsion 1 except that Sulfonic Acid Salt Group-containing Resin S1 was changed to Sulfonic Acid Salt Group-containing Resin S2 to Sulfonic Acid Salt Group-containing Resin S21. Shell Emulsions used in each Example and Comparative Example are shown in Table 3.

### Examples 2 to 14

Toner 2 to Toner 14 were obtained in the same manner as in Example 1 except that Amorphous Polyester Resin A-1 in Preparation of Oil Phase 1 of Example 1 was changed to the amorphous polyester resins shown in Table 3 and the shell emulsion in Preparation of Shell Emulsion 1 of Example 1 was changed to the shell emulsions shown in Table 3.

### Example 15

Oil Phase 15, Core Emulsion 15, Slurry Dispersion 15, and Resin Particle 15 were obtained in the same manner as in Example 1 except that the number of parts in Preparation of Oil Phase 1, Processes of Aggregation and Shell Forming, and Processes of Ceasing and Fusing were partially changed as follows to obtain Toner 15.

### Preparation of Oil Phase 15

A total of 155 parts of Liquid Dispersion 1 of Wax, 220 parts of Amorphous Polyester Resin A-1, 197 parts of Liquid Dispersion 1 of Crystalline Polyester Resin, 105 parts of ethyl acetate, and 73 parts of Master Batch 1 were admixed and stirred to dissolve and to be dispersed. During stirring, 5 parts of ethyl acetate and 30 parts of a 10 percent sodium hydroxide aqueous solution were added to obtain Oil Phase 15. The oil phase obtained had a solid portion of 50 percent.

### Processes of Aggregation and Shell Forming

A total of 170 parts of Core Emulsion 15 and 230 parts of deionized water were placed in a vessel followed by five-minute stirring. Next, 8 parts of a 20 percent magnesium sulfate solution were added dropwise followed by five-minutes of stirring and the temperature was then raised to 50 degrees C. When the particle diameter reached 5.0 μm, 17 parts of a 10 percent aqueous solution of [Shell Emulsion 1] were added. Following this, 8 parts of a 20 percent magnesium sulfate solution were added dropwise, and the mixture was stirred for another 10 minutes. Subsequently, the temperature was raised to 65 degrees C. and stirred for 30 minutes.

### Processes of Ceasing and Fusing

Then 37 parts of 20 percent sodium sulfate solution was added and the temperature was raised to 70 degrees C. When the particles achieved a desired circularity of 0.960 to 0.970, they were cooled to obtain Slurry Dispersion 15.

### Example 16

Oil Phase 16, Core Emulsion 16, Slurry Dispersion 16, and Resin Particle 16 were obtained in the same manner as in Example 1 except that the number of parts in Preparation of Oil Phase 1, Processes of Aggregation and Shell Forming, and Processes of Ceasing and Fusing were partially changed as follows to obtain Toner 16.

### Preparation of Oil Phase 16

A total of 157 parts of Liquid Dispersion 1 of Wax, 219 parts of Amorphous Polyester Resin A-1, 199 parts of Liquid Dispersion 1 of Crystalline Polyester Resin, 102 parts of ethyl acetate, and 73 parts of Master Batch 1 were admixed and stirred to dissolve and to be dispersed. During stirring, 5 parts of ethyl acetate and 30 parts of a 10 percent sodium hydroxide aqueous solution were added to obtain Oil Phase 16. The oil phase obtained had a solid portion of 50 percent.

### Processes of Aggregation and Shell Forming

A total of 170 parts of Core Emulsion 16 and 230 parts of deionized water were placed in a vessel followed by five-minutes of stirring. Next, 8 parts of a 20 percent magnesium sulfate solution were added dropwise followed by five-minutes of stirring and the temperature was then raised to 50 degrees C. When the particle diameter reached 5.0 μm, 21 parts of a 10 percent aqueous solution of [Shell Emulsion 1] were added. Following this, 8 parts of a 20 percent magnesium sulfate solution were added dropwise, and the mixture was stirred for another 10 minutes. Subsequently, the temperature was raised to 65 degrees C. and stirred for 30 minutes.

### Processes of Ceasing and Fusing

Then 37 parts of 20 percent sodium sulfate solution was added and the temperature was raised to 70 degrees C. When the particles achieved a desired circularity of 0.960 to 0.970, they were cooled to obtain Slurry Dispersion 16.

### Example 17

Oil Phase 17, Core Emulsion 17, Slurry Dispersion 17, and Resin Particle 17 were obtained in the same manner as in Example 1 except that the number of parts in Preparation of Oil Phase 1, Processes of Aggregation and Shell Forming, and Processes of Ceasing and Fusing were partially changed as follows to obtain Toner 17.

### Preparation of Oil Phase 17

A total of 165 parts of Liquid Dispersion 1 of Wax, 211 parts of Amorphous Polyester Resin A-1, 209 parts of Liquid Dispersion 1 of Crystalline Polyester Resin, 88 parts of ethyl acetate, and 77 parts of Master Batch 1 were admixed and stirred to dissolve and to be dispersed. During stirring, 5 parts of ethyl acetate and 30 parts of a 10 percent sodium hydroxide aqueous solution were added to obtain Oil Phase 17. The oil phase obtained had a solid portion of 50 percent.

### Processes of Aggregation and Shell Forming

A total of 170 parts of Core Emulsion 17 and 230 parts of deionized water were placed in a vessel followed by five minutes of stirring. Next, 8 parts of a 20 percent magnesium sulfate solution were added dropwise followed by five minutes of stirring and the temperature was then raised to 50 degrees C. When the particle diameter reached 5.0 μm, 42 parts of a 10 percent aqueous solution of [Shell Emulsion 1] were added. Following this, 9 parts of a 20 percent magnesium sulfate solution were added dropwise, and the mixture was Stirred for another 10 minutes. Subsequently, the temperature was raised to 65 degrees C. and stirred for 30 minutes.

### Processes of Ceasing and Fusing

Then 39 parts of 20 percent sodium sulfate solution was added and the temperature was raised to 70 degrees C. When the particles achieved a desired circularity of 0.960 to 0.970, they were cooled to obtain Slurry Dispersion 17.

### Example 18

Oil Phase 18, Core Emulsion 18, Slurry Dispersion 18, and Resin Particle 18 were obtained in the same manner as in Example 1 except that the number of parts in Preparation of Oil Phase 1, Processes of Aggregation and Shell Forming, and Processes of Ceasing and Fusing were partially changed as follows to obtain Toner 18.

### Preparation of Oil Phase 18

A total of 207 parts of Liquid Dispersion 1 of Wax, 169 parts of Amorphous Polyester Resin A-1, 262 parts of Liquid Dispersion 1 of Crystalline Polyester Resin, 15 parts of ethyl acetate, and 97 parts of Master Batch 1 were admixed and stirred to dissolve and to be dispersed. During stirring, 5 parts of ethyl acetate and 30 parts of a 10 percent sodium hydroxide aqueous solution were added to obtain Oil Phase 18. The oil phase obtained had a solid portion of 50 percent.

### Processes of Aggregation and Shell Forming

A total of 170 parts of Core Emulsion 18 and 230 parts of deionized water were placed in a vessel followed by five minutes of stirring. Next, 8 parts of a 20 percent magnesium sulfate solution were added dropwise followed by five minutes of stirring and the temperature was then raised to 50 degrees C. When the particle diameter reached 5.0 μm, 126 parts of a 10 percent aqueous solution of [Shell Emulsion 1] were added. Following this, 10 parts of a 20 percent magnesium sulfate solution were added dropwise, and the mixture was stirred for another 10 minutes. Subsequently, the temperature was raised to 65 degrees C. and stirred for 30 minutes.

### Processes of Ceasing and Fusing

Then 47 parts of 20 percent sodium sulfate solution was added and the temperature was raised to 70 degrees C. When the particles achieved a desired circularity of 0.960 to 0.970, they were cooled to obtain Slurry Dispersion 18.

### Example 19

Oil Phase 19, Core Emulsion 19, Slurry Dispersion 19, and Resin Particle 19 were obtained in the same manner as in Example 1 except that the number of parts in Preparation of Oil Phase 1, Processes of Aggregation and Shell Forming, and Processes of Ceasing and Fusing were partially changed as follows to obtain Toner 19.

### Preparation of Oil Phase 19

A total of 237 parts of Liquid Dispersion 1 of Wax, 139 parts of Amorphous Polyester Resin A-1, 300 parts of Liquid Dispersion 1 of Crystalline Polyester Resin, and 111 parts of Master Batch 1 were admixed and stirred to dissolve and disperse. During stirring, 5 parts of ethyl acetate and 30 parts of a 10 percent sodium hydroxide aqueous solution were added to obtain Oil Phase 19. The oil phase obtained had a solid portion of 50 percent.

### Processes of Aggregation and Shell Forming

A total of 170 parts of Core Emulsion 19 and 230 parts of deionized water were placed in a vessel followed by five minutes of stirring. Next, 8 parts of a 20 percent magnesium sulfate solution were added dropwise followed by five minutes of stirring and the temperature was then raised to 50 degrees C. When the particle diameter reached 5.0 μm, 167 parts of a 10 percent aqueous solution of [Shell Emulsion 1] were added. Following this, 11 parts of a 20 percent magnesium sulfate solution were added dropwise, and the mixture was stirred for another 10 minutes. Subsequently, the temperature was raised to 65 degrees C. and stirred for 30 minutes.

### Processes of Ceasing and Fusing

Then 50 parts of 20 percent sodium sulfate solution was added and the temperature was raised to 70 degrees C. When the particles achieved a desired circularity of 0.960 to 0.970, they were cooled to obtain Slurry Dispersion 19.

### Example 20

Oil Phase 20, Core Emulsion 20, Slurry Dispersion 20, and Resin Particle 20 were obtained in the same manner as in Example 1 except that the number of parts in Preparation of Oil Phase 1, Processes of Aggregation and Shell Forming, and Processes of Ceasing and Fusing were partially changed as follows to obtain Toner 20.

### Preparation of Oil Phase 20

A total of 241 parts of Liquid Dispersion 1 of Wax, 136 parts of Amorphous Polyester Resin A-1, 304 parts of Liquid Dispersion 1 of Crystalline Polyester Resin, and 123 parts of Master Batch 1 were admixed and stirred to dissolve and disperse. During stirring, 5 parts of ethyl acetate and 30 parts of a 10 percent sodium hydroxide aqueous solution were added to obtain Oil Phase 20. The oil phase obtained had a solid portion of 50 percent.

### Processes of Aggregation and Shell Forming

A total of 170 parts of Core Emulsion 20 and 230 parts of deionized water were placed in a vessel followed by five minutes of stirring. Next, 8 parts of a 20 percent magnesium sulfate solution were added dropwise followed by five minutes of stirring and the temperature was then raised to 50 degrees C. When the particle diameter reached 5.0 μm, 172 parts of a 10 percent aqueous solution of [Shell Emulsion 1] were added, and then 11 parts of a 20 percent magnesium sulfate solution were added dropwise and stirred for another 10 minutes. The temperature was then raised to 65 degrees C. and stirred for 30 minutes.

### Processes of Ceasing and Fusing

Then 51 parts of 20 percent sodium sulfate solution was added and the temperature was raised to 70 degrees C. When the particles achieved a desired circularity of 0.960 to 0.970, they were cooled to obtain Slurry Dispersion 20.

### Example 21

Oil Phase 21, Core Emulsion 21, Slurry Dispersion 21, and Resin Particle 21 were obtained in the same manner as in Example 1 except that Preparation of Oil Phase 1 was changed to the following Preparation of Preparation of Oil Phase 21, Shell Emulsion 1 in Preparation of Shell Emulsion 1 was changed to Shell Emulsion 15, Sulfonic Acid Salt Group-containing Resin S1 was changed to Sulfonic Acid Salt Group-containing Resin S15 to obtain Toner 21.

### Preparation of Oil Phase 21

A total of 196 parts of Liquid Dispersion 1 of Wax, 182 parts of Amorphous Polyester Resin A-4, 230 parts of Liquid Dispersion 1 of Crystalline Polyester Resin, 48 parts of ethyl acetate, 92 parts of Master Batch 1, and 50 parts of Prepolymer were admixed and stirred to dissolve and disperse. During stirring, 5 parts of ethyl acetate and 29 parts of a 10 percent sodium hydroxide aqueous solution were added to obtain Oil Phase 21. The oil phase obtained had a solid portion of 50 percent.

### Example 22

Oil Phase 22, Core Emulsion 22, Slurry Dispersion 22, and Resin Particle 22 were obtained in the same manner as in Example 1 except that Amorphous Polyester Resin A-1 was changed to Amorphous Polyester Resin A-5, Shell Emulsion 1 was changed to Shell Emulsion 16, and Sulfonic Acid Salt Group-containing Resin S1 was changed to Sulfonic Acid Salt Group-containing Resin S16 to obtain Toner 22.

### Example 23

Oil Phase 23, Core Emulsion 23, Slurry Dispersion 23, and Resin Particle 23 were obtained in the same manner as in Example 21 except that Amorphous Polyester Resin A-4 was changed to Amorphous Polyester Resin A-6, Shell Emulsion 15 was changed to Shell Emulsion 17, and Sulfonic Acid Salt Group-containing Resin S15 was changed to Sulfonic Acid Salt Group-containing Resin S17 to obtain Toner 23.

### Comparative Example 1

Oil Phase 24, Core Emulsion 24, Slurry Dispersion 24, and Resin Particle 24 were obtained in the same manner as in Example 1 except that Amorphous Polyester Resin A-1 was changed to Amorphous Polyester Resin A-7, Shell Emulsion 1 was changed to Shell Emulsion 18, and Sulfonic Acid Salt Group-containing Resin S1 was changed to Sulfonic Acid Salt Group-containing Resin S18 to obtain Toner 24.

### Comparative Example 2

Oil Phase 25, Core Emulsion 25, Slurry Dispersion 25, and Resin Particle 25 were obtained in the same manner as in Example 1 except that Amorphous Polyester Resin A-1 was changed to Amorphous Polyester Resin A-8, Shell Emulsion 1 was changed to Shell Emulsion 19, and Sulfonic Acid Salt Group-containing Resin S1 was changed to Sulfonic Acid Salt Group-containing Resin S19 to obtain Toner 25.

### Comparative Example 3

Oil Phase 26, Core Emulsion 26, Slurry Dispersion 26, and Resin Particle 26 were obtained in the same manner as in Example 1 except that Shell Emulsion 1 was changed to Shell Emulsion 20, and Sulfonic Acid Salt Group-containing Resin S1 was changed to Sulfonic Acid Salt Group-containing Resin S20 to obtain Toner 26.

### Comparative Example 4

Oil Phase 27, Core Emulsion 27, Slurry Dispersion 27, and Resin Particle 27 were obtained in the same manner as in Example 1 except that Shell Emulsion 1 was changed to Shell Emulsion 20, and Sulfonic Acid Salt Group-containing Resin S1 was not used to obtain Toner 27.

### Preparation of Oil Phase 27

A total of 150 parts of Liquid Dispersion 1 of Wax, 226 parts of Amorphous Polyester Resin A-1, 190 parts of Liquid Dispersion 1 of Crystalline Polyester Resin, 114 parts of ethyl acetate, and 70 parts of Master Batch 1 were admixed and stirred to dissolve and disperse. During stirring, 5 parts of ethyl acetate and 30 parts of a 10 percent sodium hydroxide aqueous solution were added to obtain Oil Phase 27. The oil phase obtained had a solid portion of 50 percent.

### Processes of Aggregation and Shell Forming

A total of 170 parts of Core Emulsion 27 and 230 parts of deionized water were placed in a vessel followed by five minutes of stirring. Next, 8 parts of a 20 percent magnesium sulfate solution were added dropwise followed by five minutes of stirring and the temperature was then raised to 50 degrees C. Thereafter, the particle diameter became 5.0 μm.

### Processes of Ceasing and Fusing

Then 41 parts of 27 percent sodium sulfate solution was added and the temperature was raised to 70 degrees C. When the particles achieved a desired circularity of 0.960 to 0.970, they were cooled to obtain Slurry Dispersion 20.

### Comparative Example 5

Oil Phase 28, Core Emulsion 28, Slurry Dispersion 28, and Resin Particle 28 were obtained in the same manner as in Comparative Example 1 except that Shell Emulsion 18 was changed to Shell Emulsion 21 and Sulfonic Acid Salt Group-containing Resin S18 was changed to Sulfonic Acid Salt Group-containing Resin S21 to obtain Toner 28.

### Comparative Example 6

Oil Phase 29, Core Emulsion 29, Slurry Dispersion 29, and Resin Particle 29 were obtained in the same manner as in Comparative Example 5 except that Shell Emulsion 21 and Sulfonic Acid Salt Group-containing Resin S21 were not used to obtain Toner 29.

### Processes of Aggregation and Shell Forming

A total of 170 parts of Core Emulsion 29 and 230 parts of deionized water were placed in a vessel followed by five minutes of stirring. Next, 8 parts of a 20 percent magnesium sulfate solution were added dropwise followed by five minutes of stirring and the temperature was then raised to 50 degrees C. Thereafter, the particle diameter became 5.0 μm.

### Processes of Ceasing and Fusing

Then 41 parts of 29 percent sodium sulfate solution was added and the temperature was raised to 70 degrees C. When the particles achieved a desired circularity of 0.960 to 0.970, they were cooled to obtain Slurry Dispersion 20.

The components of Core Shell Emulsions and Shell Emulsions prepared in Examples and Comparative Examples are listed in Table 3 below.

The components of crystalline Polyester Resin 1, Liquid Dispersion 1 of Wax, and Master Batch 1 used for preparing Core Emulsion are omitted because they are the same as those used in each Example and Comparative Example.

TABLE 3

| | | | | | Shell Emulsion No. | |
|---|---|---|---|---|---|---|
| | | | Core Emulsion No. | | | Sulfonic Acid Salt |
| | Resin | | Core | Amorphous Polyester | Shell | Group-containing |
| | particle No. | Toner No. | Emulsion No. | Resin No. | Emulsion No. | Resin No. |
| Example 1 | Resin | Toner 1 | 1 | A-1 | 1 | S1 |
| | particle 1 | | | | | |
| Example 2 | Resin | Toner 2 | 2 | A-2 | 2 | S2 |
| | particle 2 | | | | | |
| Example 3 | Resin | Toner 3 | 3 | A-3 | 3 | S3 |
| | particle 3 | | | | | |
| Example 4 | Resin | Toner 4 | 4 | A-1 | 4 | S4 |
| | particle 4 | | | | | |
| Example 5 | Resin | Toner 5 | 5 | A-1 | 5 | S5 |
| | particle 5 | | | | | |
| Example 6 | Resin | Toner 6 | 6 | A-1 | 6 | S6 |
| | particle 6 | | | | | |
| Example 7 | Resin | Toner 7 | 7 | A-1 | 7 | S7 |
| | particle 7 | | | | | |
| Example 8 | Resin | Toner 8 | 8 | A-1 | 8 | S8 |
| | particle 8 | | | | | |
| Example 9 | Resin | Toner 9 | 9 | A-1 | 9 | S9 |
| | particle 9 | | | | | |
| Example 10 | Resin | Toner 10 | 10 | A-1 | 10 | S10 |
| | particle 10 | | | | | |
| Example 11 | Resin | Toner 11 | 11 | A-1 | 11 | S11 |
| | particle 11 | | | | | |
| Example 12 | Resin | Toner 12 | 12 | A-1 | 12 | S12 |
| | particle 12 | | | | | |
| Example 13 | Resin | Toner 13 | 13 | A-1 | 13 | S13 |
| | particle 13 | | | | | |
| Example 14 | Resin | Toner 14 | 14 | A-1 | 14 | S14 |
| | particle 14 | | | | | |
| Example 15 | Resin | Toner 15 | 15 | A-1 | 1 | S1 |
| | particle 15 | | | | | |
| Example 16 | Resin | Toner 16 | 16 | A-1 | 1 | S1 |
| | particle 16 | | | | | |
| Example 17 | Resin | Toner 17 | 17 | A-1 | 1 | S1 |
| | particle 17 | | | | | |
| Example 18 | Resin | Toner 18 | 18 | A-1 | 1 | S1 |
| | particle 18 | | | | | |
| Example 19 | Resin | Toner 19 | 19 | A-1 | 1 | S1 |
| | particle 19 | | | | | |
| Example 20 | Resin | Toner 20 | 20 | A-1 | 1 | S1 |
| | particle 20 | | | | | |
| Example 21 | Resin | Toner 21 | 21 | A-4 | 15 | S15 |
| | particle 21 | | | | | |
| Example 22 | Resin | Toner 22 | 22 | A-5 | 16 | S16 |
| | particle 22 | | | | | |
| Example 23 | Resin | Toner 23 | 23 | A-6 | 17 | S17 |
| | particle 23 | | | | | |
| Comparative | Resin | Toner 24 | 24 | A-7 | 18 | S18 |
| Example 1 | particle 24 | | | | | |
| Comparative | Resin | Toner 25 | 25 | A-8 | 19 | S19 |
| Example 2 | particle 25 | | | | | |
| Comparative | Resin | Toner 26 | 26 | A-1 | 20 | S20 |
| Example 3 | particle 26 | | | | | |
| Comparative | Resin | Toner 27 | 27 | A-1 | — | — |
| Example 4 | particle 27 | | | | | |
| Comparative | Resin | Toner 28 | 28 | A-1 | 21 | S21 |
| Example 5 | particle 28 | | | | | |
| Comparative | Resin | Toner 29 | 29 | A-1 | — | — |
| Example 6 | particle 29 | | | | | |

### Evaluation

### High Temperature Fixability

An unfixed black solid image was formed on plain paper at 0.6 mg/cm² using the fixing unit of a color multifunction peripheral (imagio MP C5503, available from Ricoh Co., Ltd.) and fixed at various temperatures. The temperature at which hot offset occurred was measured, and graded regarding the high temperature fixability according to the criteria outlined below.

### Evaluation Criteria

S: 190 or higher degrees C.
A: 180 to lower than 190 degrees C.
B: 170 to lower than 180 degrees C.
C: Lower than 170 degrees C.

### Low Temperature Fixability

An unfixed black solid image was formed on plain paper at 0.6 mg/cm² using the fixing unit of a color multifunction peripheral (imagio MP C5503, available from Ricoh Co., Ltd.) and fixed at various temperatures. The temperature at which cold offset occurred was measured, and graded regarding the high temperature fixability according to the criteria outlined below.

### Evaluation Criteria

S: Lower than 120 degrees C.
A: 120 to lower than 125 degrees C.
B: 125 to lower than 130 degrees C.
C: 130 or higher degrees C.

### High Temperature Storage Stability

A 50 mL glass container was filled with Toner, left in a constant bath at 50 degrees C. for 24 hours, and cooled down to 24 degrees C. The Toner was subjected to the penetration test in accordance with JISK 2235-1991 (Petroleum waxes) and its degree of penetration (mm) was measured to evaluate the high temperature storage stability.

### Evaluation Criteria

S: Degree of penetration was 20 or more mm
A: Degree of penetration was 15 to less than 20 mm
B: Degree of penetration was 10 to less than 15 mm
C: Degree of penetration was less than 10 mm

### Durability

Toner was removed from the developing agent after printing by a photocopier with a run length of 100,000 sheets. The weight of the carrier remaining was measured and defined as W1. This carrier was placed in toluene to dissolve the molten material. The weight after rinsing and drying is defined as W2. The spent ratio was obtained from the following relationship and evaluated according to the following evaluation criteria.

$$Spent ratio ( percent ) = ( W 1 - W 2 / W 1 ) \times 100$$

### Evaluation Criteria

S: 0 to less than 0.01 percent by mass
A: 0.01 to less than 0.02 percent by mass
B: 0.02 to less than 0.05 percent by mass
C: 0.05 or greater than 0.05 percent by mass

### Chargeability

A total of 6 g of a two-component developing agent was weighed and placed in a sealable metal cylinder followed by stirring at 280 rpm to obtain the charge size by blow-off method. The stirring was carried out for 15 seconds (TA15), 60 seconds (TA60), and 600 seconds (TA600). The carrier used was TEFV 200/300, available from Powdertech CO., Ltd.
S: 36 or greater
A: 33 to less than 36
B: 30 to less than 33
C: Less than 30

The evaluation results of the toners of Examples and Comparative Examples are shown in Tables 4-1 and 4-2.

TABLE 4-1

| | | Example No. | | | | |
|---|---|---|---|---|---|---|
| | | 1 | 2 | 3 | 4 | 5 |
| | | Toner 1 | Toner 2 | Toner 3 | Toner 4 | Toner 5 |
| Evaluation | Low temperature fixability | B | A | S | B | B |
| | High temperature fixability | A | A | B | A | A |
| | Heat-resistant storage stability | S | A | B | B | A |
| | Durability | S | A | B | B | A |

| | | | | | | | |
|---|---|---|---|---|---|---|---|
| | Chargeability | TA15 | S | S | S | B | A |
| | | TA60 | S | S | S | B | A |
| | | TA600 | S | S | S | B | A |
| Oil phase | Amorphous polyester resin | Part | 68 | 68 | 68 | 68 | 68 |
| | Shell emulsion | Part | 20 | 20 | 20 | 20 | 20 |
| | Liquid dispersion of crystalline polyester | Part | 6 | 6 | 6 | 6 | 6 |
| | resin | | | | | | |
| | Prepolymer | Part | 0 | 0 | 0 | 0 | 0 |
| | Resin | Part | 94 | 94 | 94 | 94 | 94 |
| | Liquid dispersion of wax | Part | 6 | 6 | 6 | 6 | 6 |
| | Binder resin | Part | 100 | 100 | 100 | 100 | 100 |
| | Pigment master batch | Part | 8 | 8 | 8 | 8 | 8 |
| | Toner | Part | 108 | 108 | 108 | 108 | 108 |
| Binder | Ratio of environmentally compatible resin | Percent | 52.4 | 52.4 | 52.4 | 40.5 | 41.0 |
| resin | Ratio of biomass-derived resin | Percent | 10.5 | 18.3 | 23.6 | 8.1 | 8.1 |
| | Ratio of recycle-based resin | Percent | 41.9 | 34.1 | 28.8 | 32.4 | 32.9 |
| | Ratio of petroleum-based resin | Percent | 41.6 | 41.6 | 41.6 | 53.5 | 53.0 |
| Shell | SP value | | 12.0 | 12.1 | 11.9 | 9.5 | 10.0 |
| | Content of sulfonic acid salt group | mol percent | 5 | 5 | 5 | 5 | 5 |
| | Acid value | | 27.3 | 27.1 | 27.2 | 26.9 | 27.2 |
| | Volume average particle diameter | nm | 50.0 | 50.0 | 50.0 | 51.0 | 52.0 |
| | Solid emulsion portion | Percent | 30 | 30 | 30 | 30 | 30 |
| | Content of shell resin | percent | 20 | 20 | 20 | 20 | 20 |
| | | by mass | | | | | |

| | | Example No. | | | | |
|---|---|---|---|---|---|---|
| | | 6 | 7 | 8 | 9 | 10 |
| | | Toner 6 | Toner 7 | Toner 8 | Toner 9 | Toner 10 |
| Evaluation | Low temperature fixability | B | B | B | B | B |
| | High temperature fixability | A | A | A | A | A |
| | Heat-resistant storage stability | S | A | B | A | S |
| | Durability | S | A | B | A | S |

| | | | | | | | |
|---|---|---|---|---|---|---|---|
| | Chargeability | TA15 | S | A | B | B | A |
| | | TA60 | S | A | B | B | A |
| | | TA600 | S | A | B | A | A |
| Oil phase | Amorphous polyester resin | Part | 68 | 68 | 68 | 68 | 68 |
| | Shell emulsion | Part | 20 | 20 | 20 | 20 | 20 |
| | Liquid dispersion of crystalline polyester | Part | 6 | 6 | 6 | 6 | 6 |
| | resin | | | | | | |
| | Prepolymer | Part | 0 | 0 | 0 | 0 | 0 |
| | Resin | Part | 94 | 94 | 94 | 94 | 94 |
| | Liquid dispersion of wax | Part | 6 | 6 | 6 | 6 | 6 |
| | Binder resin | Part | 100 | 100 | 100 | 100 | 100 |
| | Pigment master batch | Part | 8 | 8 | 8 | 8 | 8 |
| | Toner | Part | 108 | 108 | 108 | 108 | 108 |
| Binder | Ratio of environmentally compatible resin | Percent | 46.3 | 54.7 | 51.6 | 52.8 | 52.7 |
| resin | Ratio of biomass-derived resin | Percent | 8.1 | 9.7 | 9.8 | 10.5 | 10.5 |
| | Ratio of recycle-based resin | Percent | 38.2 | 45.1 | 41.8 | 42.3 | 42.2 |
| | Ratio of petroleum-based resin | Percent | 47.7 | 39.3 | 42.4 | 41.2 | 41.3 |
| Shell | SP value | | 11.1 | 13.0 | 13.5 | 12 | 12.2 |
| | Content of sulfonic acid salt group | mol percent | 5 | 5 | 5 | 1 | 2 |
| | Acid value | | 27.1 | 30.3 | 33.2 | 27.1 | 27.3 |
| | Volume average particle diameter | nm | 51.0 | 51.0 | 51.0 | 62.0 | 62.0 |
| | Solid emulsion portion | Percent | 30 | 30 | 30 | 30 | 30 |
| | Content of shell resin | percent | 20 | 20 | 20 | 20 | 20 |
| | | by mass | | | | | |

| | | Example No. | | | | |
|---|---|---|---|---|---|---|
| | | 11 | 12 | 13 | 14 | 15 |
| | | Toner 11 | Toner 12 | Toner 13 | Toner 14 | Toner 15 |
| Evaluation | Low temperature fixability | B | B | B | B | A |
| | High temperature fixability | A | A | A | A | A |
| | Heat-resistant storage stability | S | S | A | B | B |
| | Durability | S | S | A | B | B |

| | | | | | | | |
|---|---|---|---|---|---|---|---|
| | Chargeability | TA15 | S | S | S | B | B |
| | | TA60 | S | S | S | A | A |
| | | TA600 | S | S | S | A | A |
| Oil | Amorphous polyester resin | Part | 68 | 68 | 68 | 68 | 84 |
| phase | Shell emulsion | Part | 20 | 20 | 20 | 20 | 4 |
| | Liquid dispersion of crystalline polyester | Part | 6 | 6 | 6 | 6 | 6 |
| | resin | | | | | | |
| | Prepolymer | Part | 0 | 0 | 0 | 0 | 0 |
| | Resin | Part | 94 | 94 | 94 | 94 | 94 |
| | Liquid dispersion of wax | Part | 6 | 6 | 6 | 6 | 6 |
| | Binder resin | Part | 100 | 100 | 100 | 100 | 100 |
| | Pigment master batch | Part | 8 | 8 | 8 | 8 | 8 |
| | Toner | Part | 108 | 108 | 108 | 108 | 108 |
| Binder | Ratio of environmentally compatible resin | Percent | 52.5 | 52.1 | 51.9 | 51.9 | 52.4 |
| resin | Ratio of biomass-derived resin | Percent | 10.5 | 10.4 | 10.4 | 10.3 | 10.5 |
| | Ratio of recycle-based resin | Percent | 42.0 | 41.7 | 41.6 | 41.5 | 41.9 |
| | Ratio of petroleum-based resin | Percent | 41.5 | 41.9 | 42.1 | 42.1 | 41.6 |
| Shell | SP value | | 12.1 | 11.9 | 12.2 | 12.1 | 12 |
| | Content of sulfonic acid salt group | mol percent | 4 | 8 | 10 | 11 | 5 |
| | Acid value | | 27.5 | 27.4 | 27.3 | 27.3 | 27.3 |
| | Volume average particle diameter | nm | 55.0 | 48.0 | 45.0 | 45.0 | 50.0 |
| | Solid emulsion portion | Percent | 30 | 30 | 30 | 30 | 30 |
| | Content of shell resin | percent | 20 | 20 | 20 | 20 | 4 |
| | | by mass | | | | | |

| | | Example No. | | | |
|---|---|---|---|---|---|
| | | 16 | 17 | 18 | 19 |
| | | Toner 16 | Toner 17 | Toner 18 | Toner 19 |
| Evaluation | Low temperature fixability | A | A | B | B |
| | High temperature fixability | A | A | A | A |
| | High temperature storage stability | A | S | S | S |
| | Durability | A | S | S | S |

| | | | | | | |
|---|---|---|---|---|---|---|
| | Chargeability | TA15 | A | S | S | S |
| | | TA60 | A | S | S | S |
| | | TA600 | A | S | S | S |
| Oil phase | Amorphous polyester resin | Part | 83 | 78 | 58 | 48 |
| | Shell emulsion | Part | 5 | 10 | 30 | 40 |
| | Liquid dispersion of crystalline polyester | Part | 6 | 6 | 6 | 6 |
| | resin | | | | | |
| | Prepolymer | Part | 0 | 0 | 0 | 0 |
| | Resin | Part | 94 | 94 | 94 | 94 |
| | Liquid dispersion of wax | Part | 6 | 6 | 6 | 6 |
| | Binder resin | Part | 100 | 100 | 100 | 100 |
| | Pigment master batch | Part | 8 | 8 | 8 | 8 |
| | Toner | Part | 108 | 108 | 108 | 108 |
| Binder | Ratio of environmentally compatible resin | Percent | 52.4 | 52.4 | 52.4 | 52.4 |
| resin | Ratio of biomass-derived resin | Percent | 10.5 | 10.5 | 10.5 | 10.5 |
| | Ratio of recycle-based resin | Percent | 41.9 | 41.9 | 41.9 | 41.9 |
| | Ratio of petroleum-based resin | Percent | 41.6 | 41.6 | 41.6 | 41.6 |
| Shell | SP value | | 12 | 12 | 12 | 12 |
| | Content of sulfonic acid salt group | mol percent | 5 | 5 | 5 | 5 |
| | Acid value | | 27.3 | 27.3 | 27.3 | 27.3 |
| | Volume average particle diameter | nm | 50.0 | 50.0 | 50.0 | 50.0 |
| | Solid emulsion portion | Percent | 30 | 30 | 30 | 30 |
| | Content of shell resin | percent | 5 | 10 | 30 | 40 |
| | | by mass | | | | |

| | | Example No. | | | |
|---|---|---|---|---|---|
| | | 20 | 21 | 22 | 23 |
| | | Toner 20 | Toner 21 | Toner 22 | Toner 23 |
| Evaluation | Low temperature fixability | B | S | B | S |
| | High temperature fixability | A | S | A | S |
| | High temperature storage stability | A | S | S | S |
| | Durability | A | S | S | S |

| | | | | | | |
|---|---|---|---|---|---|---|
| | Chargeability | TA15 | A | S | S | S |
| | | TA60 | A | S | S | S |
| | | TA600 | A | S | S | S |
| Oil phase | Amorphous polyester resin | Part | 47 | 62 | 68 | 62 |
| | Shell emulsion | Part | 41 | 20 | 20 | 20 |
| | Liquid dispersion of crystalline polyester | Part | 6 | 6 | 6 | 6 |
| | resin | | | | | |
| | Prepolymer | Part | 0 | 6 | 0 | 6 |
| | Resin | Part | 94 | 94 | 94 | 94 |
| | Liquid dispersion of wax | Part | 6 | 6 | 6 | 6 |
| | Binder resin | Part | 100 | 100 | 100 | 100 |
| | Pigment master batch | Part | 8 | 8 | 8 | 8 |
| | Toner | Part | 108 | 108 | 108 | 108 |
| Binder | Ratio of environmentally compatible resin | Percent | 52.4 | 52.3 | 82.4 | 82.0 |
| resin | Ratio of biomass-derived resin | Percent | 10.5 | 10.5 | 16.5 | 16.4 |
| | Ratio of recycle-based resin | Percent | 41.9 | 41.9 | 65.9 | 65.6 |
| | Ratio of petroleum-based resin | Percent | 41.6 | 41.7 | 11.6 | 12.0 |
| Shell | SP value | | 12 | 12.2 | 12.0 | 12.0 |
| | Content of sulfonic acid salt group | mol percent | 5 | 5 | 5 | 5 |
| | Acid value | | 27.3 | 27.2 | 27.1 | 27.1 |
| | Volume average particle diameter | nm | 50.0 | 50.0 | 50.0 | 50.0 |
| | Solid emulsion portion | Percent | 30 | 30 | 30 | 30 |
| | Content of shell resin | percent | 41 | 20 | 20 | 20 |
| | | by mass | | | | |

| | | | Comparative Example No. | | | | | |
|---|---|---|---|---|---|---|---|---|
| | | | 1 | 2 | 3 | 4 | 5 | 6 |
| | | | Toner 24 | Toner 25 | Toner 26 | Toner 27 | Toner 28 | Toner 29 |
| Evaluation | Low temperature fixability | | A | A | A | C | A | C |
| | High temperature fixability | | A | A | A | C | A | C |
| | High temperature storage stability | | C | C | A | C | C | C |
| | Durability | | C | C | A | C | C | C |
| | Chargeability | TA15 | A | A | C | C | C | C |
| | | TA60 | A | A | C | C | C | C |
| | | TA600 | A | A | C | C | C | C |
| Oil phase | Amorphous polyester resin | Part | 68 | 68 | 68 | 88 | 68 | 88 |
| | Shell emulsion | Part | 20 | 20 | 20 | 0 | 20 | 0 |
| | Liquid dispersion of crystalline polyester | Part | 6 | 6 | 6 | 6 | 6 | 6 |
| | resin | | | | | | | |
| | Prepolymer | Part | 0 | 0 | 0 | 0 | 0 | 0 |
| | Resin | Part | 94 | 94 | 94 | 94 | 94 | 94 |
| | Liquid dispersion of wax | Part | 6 | 6 | 6 | 6 | 6 | 6 |
| | Binder resin | Part | 100 | 100 | 100 | 100 | 100 | 100 |
| | Pigment master batch | Part | 8 | 8 | 8 | 8 | 8 | 8 |
| | Toner | Part | 108 | 108 | 108 | 108 | 108 | 108 |
| Binder | Ratio of environmentally compatible resin | Percent | 52.4 | 52.4 | 53.0 | 52.4 | 52.4 | 52.4 |
| resin | Ratio of biomass-derived resin | Percent | 41.9 | 28.8 | 10.6 | 10.5 | 41.9 | 41.9 |
| | Ratio of recycle-based resin | Percent | 10.5 | 23.6 | 42.4 | 41.9 | 10.5 | 10.5 |
| | Ratio of petroleum-based resin | Percent | 41.6 | 41.6 | 41.0 | 41.6 | 41.6 | 41.6 |
| Shell | SP value | | 10.5 | 10.5 | 11.8 | — | 10.5 | — |
| | Content of sulfonic acid salt group | mol percent | 5 | 5 | 0 | 0 | 0 | 0 |
| | Acid value | | 26.8 | 26.8 | 26.7 | — | 26.6 | — |
| | Volume average particle diameter | nm | 50 | 50 | 52 | — | 52 | — |
| | Solid emulsion portion | Percent | 30 | 30 | 30 | — | 30 | — |
| | Content of shell resin | percent | 20 | 20 | 20 | — | 20 | — |
| | | by mass | | | | | | |

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A resin particle comprising:
a binder resin comprising a biomass-derived resin and a recycle-based resin,
the resin particle including a core-shell structure including:
a core layer; and
a shell layer that comprises a resin having a sulfonic acid salt group,
wherein, in the binder resin, a proportion (percent by mass) of the biomass-derived resin and a proportion (percent by mass) of the recycle-based resin satisfy the following relationship 1:
proportion of recycle-based resin>proportion of biomass-derived resin Relationship 1.

2. The resin particle according to claim 1, wherein the shell layer further comprises a polyester resin having a sulfonic acid salt group with an SP value of from 10 to 13 (cal/cm³)^{0.5}.

3. The resin particle according to claim 2, wherein a content of the sulfonic acid salt group in the polyester resin is from 2 to 10 percent by mol.

4. The resin particle according to claim 3, wherein the polyester resin accounts for 5 to 40 percent by mass of the resin particle.

5. The resin particle according to claim 1, wherein a proportion of the biomass-derived resin and the recycle-based resin accounts for 80 or more percent by mass of the binder resin.

6. The resin particle according to claim 1, wherein the recycle-based resin comprises at least one of polyethylene terephthalate or polybutylene terephthalate.

7. The resin particle according to claim 1, wherein the binder resin comprises a polyester resin.

8. The resin particle according to claim 7, wherein the polyester resin comprises a crystalline polyester resin.

9. The resin particle according to claim 1, further comprising a colorant and a release agent.

10. A toner comprising:
the resin particle of claim 9; and
an external additive added to the resin particle.

11. A developing agent comprising:
a toner comprising:
a resin particle comprising a binder resin comprising;
a biomass-derived resin;
a recycle-based resin;
a colorant; and
a release agent;
the resin particle including a core-shell structure including:
a core layer; and
a shell layer that comprises a resin having a sulfonic acid salt group, the binder resin; and
an external additive added to the mother toner particle,
wherein, in the binder resin, a proportion (percent by mass) of the biomass-derived resin and a proportion (percent by mass) of the recycle-based resin satisfy the following relationship 1:
proportion of recycle-based resin>proportion of biomass-derived resin Relationship 1.

12. A developing agent accommodating unit comprising:
the developing agent of claim 11; and
a body that contains the developing agent.

13. A method of manufacturing the resin particle of claim 1, comprising:
dissolving or dispersing at least one of the binder resin comprising the biomass-derived resin and the recycle-based resin or a precursor of the binder resin in an organic solvent to obtain a solution;
adding water to the solution to induce a phase inversion of a water-in-oil liquid dispersion to an oil-in-water liquid dispersion;
removing the organic solvent from the oil-in-water liquid dispersion to obtain a fine particle liquid dispersion;
aggregating fine particles in the fine particle liquid dispersion to obtain aggregated particle;
forming the shell layer containing a polyester resin with a sulfonic acid salt group on the aggregated particle;
fusing the aggregated particle having the shell layer to obtain a fused aggregated particle;
annealing the fused aggregated particle to obtain an annealed particle; and
rinsing and drying the annealed particle.

14. The method according to claim 13, wherein the precursor comprises a prepolymer having a functional group reactive with an active hydrogen group.

15. An image forming apparatus comprising:
a latent electrostatic image bearer;
a latent electrostatic image forming device to form a latent electrostatic image on the latent electrostatic image bearer;
a developing device to develop the latent electrostatic image with the toner of claim 10 to form a visible image;
a transfer device to transfer the visible image onto a recording medium to obtain a transfer image; and
a fixing device to fix the transfer image transferred to the recording medium.

16. An image forming apparatus comprising:
a latent electrostatic image bearer;
a latent electrostatic image forming device to form a latent electrostatic image on the latent electrostatic image bearer;
a developing device to develop the latent electrostatic image with the developing agent of claim 11 to form a visible image;
a transfer device to transfer the visible image onto a recording medium to obtain a transfer image; and
a fixing device to fix the transfer image transferred to the recording medium.

17. An image forming method comprising:
forming a latent electrostatic image on a latent electrostatic image bearer;
developing the latent electrostatic image with the toner of claim 10 to obtain a visible image;
transferring the visible image to a recording medium; and
fixing the visible image on the recording medium.

18. An image forming method comprising:
forming a latent electrostatic image on a latent electrostatic image bearer;
developing the latent electrostatic image with the developing agent of claim 11 to obtain a visible image;
transferring the visible image to a recording medium; and
fixing the visible image on the recording medium.
